(19) United States
(12) Patent Application Publication
(10) Pub. No.: US 2015/0104762 A1
(43) Pub. Date: Apr. 16, 2015

(54) Adaptive Grammar Instruction

(71) Applicant: Apollo Group, Inc., Phoenix, AZ (US)

(72) Inventors: Clifton Luke, San Francisco, CA (US); Joanna Morey, Neenah, WI (US); Brendon Towle, Los Angeles, CA (US)

(73) Assignee: APOLLO GROUP, INC., PHOENIX, AZ (US)

(21) Appl. No.: 14/053,519

(22) Filed: Oct. 14, 2013

(51) Int. Cl. G09B 17/00

(52) U.S. Cl. CPC G09B 17/003
USPC 434/169

(57) ABSTRACT

A grammar teaching system maintains and updates a mastery estimate for a grammar skill and displays an updated visual indication of this estimation. Based on user answers to grammar problems, the system updates the mastery estimate for the grammar skill. Also, a step of a grammar problem is associated with an ordered list of hints. When the user requests a hint for the problem step, the system identifies a position in the list of hints based on how many times the user has previously requested hints for the step. The system displays text that is from the hint at the identified position in the list. Further, a hint for a grammar problem step includes pointer information that refers to a portion of a sentence for the grammar problem. When the system displays the hint, the system highlights the portion of the sentence that is referred to in the pointer information.

### CROSS-REFERENCE TO RELATED APPLICATIONS

This application claims the benefit of Provisional Appln. No. 61/______, filed Oct. 14, 2013, titled “Adaptive Grammar Instruction” (attorney docket number 60201-0358), the entire contents of which is hereby incorporated by reference as if fully set forth herein, under 35 U.S.C. §119(e). This application is related to application Ser. No. 13/875,107, titled “Multi-Layered Cognitive Tutor”, filed May 1, 2013, and to Appln. Ser. No. ______, titled “Adaptive Grammar Instruction For Run-On Sentences” filed Oct. 14, 2013, (Attorney Ref. No. 60201-0350), the entire contents of each of which is hereby incorporated by reference as if fully set forth herein.

### FIELD OF THE INVENTION

The present invention relates to teaching natural language rules of grammar, and, more specifically, to an adaptive grammar teaching system configured to provide graduated and problem-specific help for grammar problems and to display a visual representation of an estimate of how well a user has mastered particular grammar skills.

### BACKGROUND

Natural languages are spoken languages (such as American English), which have grammar rules governing the composition of the natural language. When a person has not learned the proper rules of grammar for a natural language, the student encounters difficulty in communicating using the natural language. Lack of understanding of the rules of grammar for a natural language limits a person's ability to communicate effectively through writing. For example, it may be particularly difficult for a person that does not understand the grammatical rules of natural language to write an error-free research paper or formal letter.

Grammar checkers, e.g., Grammerly.com, Thelma Thistleblossom, and grammar checkers included with document editors such as Microsoft Word, identify certain types of grammatical errors in written documents. However, grammar error identification/correction is not the same as teaching grammar rules, even when the grammar checker indicates why each identified error is an error. Thus, grammar checkers generally do not teach the rules of grammar, nor do grammar checkers target particular problems that users have with grammatical rules. Also, at times, the grammar checkers identify “errors” that are not grammatical errors at all, and rely on the knowledge of the user to ultimately determine whether an error exists. Thus, grammar checkers are generally ineffective at teaching a user the rules of grammar of a natural language.

Some English courses, e.g., in secondary and higher education, attempt to teach the rules of natural language grammar, largely using face-to-face teaching techniques, quizzes, and other activities. At times, automation is used in connection with such traditional English courses. However, this automation generally consists of providing a student with lesson material and/or multiple-choice questions, and giving the student feedback on the student's selected answers. It can be difficult for an English teacher to identify and aid each student enrolled in a class with the students' individual grammar misconceptions, especially since classes tend to be large and students tend to have a wide range of skill gaps with respect to mastery of English grammar rules. At least the above mentioned deficiencies can allow students to complete English courses without learning all of the natural language grammar rules that they need to produce effective written communications.

Also, automated testing may be used to identify a level of proficiency at which a student is performing. For example, an automated test includes a pool of test questions that are graded by difficulty. The student is presented with test questions of increasing difficulty level until the student does not correctly answer a threshold number of questions that are of a particular difficulty level. The automated test determines that the user is proficient up to the identified difficulty level. However, such automated tests do not identify the particular misconceptions that users have with grammatical rules, nor do such tests teach users about the rules of grammar of a natural language.

Therefore, it would be beneficial to provide an automated grammar teaching system that is configured to adaptively teach natural language grammar concepts targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules.

FIG. 2 depicts a flowchart for tracking and displaying a user's estimated probability of grammar skill mastery.

FIG. 3 depicts a graphical user interface that includes a plurality of visual indications of estimations of how well a particular user has mastered particular grammar skills.

FIGS. 4 and 5 depict graphical user interfaces in which the visual indications of estimations of how well a particular user has mastered particular grammar skills reflect an updated mastery estimation.

FIG. 6 depicts a flowchart for displaying one of an ordered list of hint information in response to a request for hint information from a user.

FIG. 7 depicts a graphical user interface that includes a natural language sentence and directions to instruct the user as to what the user must do to complete the current step of the problem for the sentence.

FIGS. 8A-8B depict graphical user interfaces with displayed hints from an ordered list of portions of hint information associated with the current grammar problem step.

FIGS. 9A-9C depict graphical user interfaces with displayed hints from an ordered list of portions of hint information associated with the current grammar problem step.

FIG. 10 depicts a flowchart for using hint pointers to highlight portions of a displayed sentence in a grammar problem.

FIG. 11 depicts a natural language sentence marked up with example metadata.

FIGS. 12 and 13 depict graphical user interfaces that display hint information and that highlight particular portions of displayed natural language sentences.

FIGS. 14A-14B depict graphical user interfaces that display highlights of particular portions of a displayed natural language sentence that is part of a displayed paragraph.

FIG. 15 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized differentiated instruction to users, providing lessons, adaptive practice, and adaptive feedback in real time to build each student's skills for the rules of natural language grammar. Grammar problems are configured to address students' continuous learning needs for natural language grammar.

Embodiments of the system display, to a user, grammar problems with one or more sentences that contain grammar errors, and allows the user to identify a location of and/or correct the grammar errors. The automated grammar teaching system produces grammar problems that are classified using granularly-defined grammar skills. The thorough treatment of grammar skills by the system's grammar problems is based on identification and correction of common errors that users make when formulating natural language. The system uses information from interactions with the user to estimate and track the probability that a user has mastered particular grammar skills. The system displays to the user practice problems for grammar skills that the user has not yet mastered based, at least in part, on the user's tracked mastery estimates, to continue building those grammar skills.

According to embodiments, there are different problem types in the system database. Some grammar problems are compare/contrast problems where the system presents a user with a set of two or more sentences, and asks the user to determine whether or not there are grammar issues within each sentence. Other problem types make more extensive use of optional scaffolding tasks to help the user determine whether or not a sentence in question includes a grammar error.

According to an embodiment, the system maintains and displays a “mastery estimate” for a grammar skill. As used herein, a mastery estimate of a particular grammar skill represents a probability that a user has mastered the particular grammar skill Based on the answers that the user provides for grammar problems associated with the particular grammar skill, the system updates the mastery estimate for the particular grammar skill and updates the visual indication of the mastery estimate.

Grammar problems are often solved in multiple steps. According to an embodiment, an ordered list of hint information is maintained for a particular step of a grammar problem. When the system receives, from the user, a request for hint information in connection with the particular step of the grammar problem, the system identifies a position in the ordered list of hint information based, at least in part, on how many times the user has previously requested hint information for the particular step of the grammar problem. The system displays hint text, via a graphical user interface, that is from the hint information at the identified position in the ordered hint list.

According to an embodiment, a particular portion of hint information for a grammar problem step includes hint pointer information that refers to one or more particular portions of a natural language sentence for the grammar problem. For example, a hint pointer refers to a grammatical structure, such as independent clauses. When the system displays the particular portion of hint information, the system highlights the particular portion of the natural language sentence that is referred to in the hint pointer information.

### Adaptive Grammar Instructions Architecture

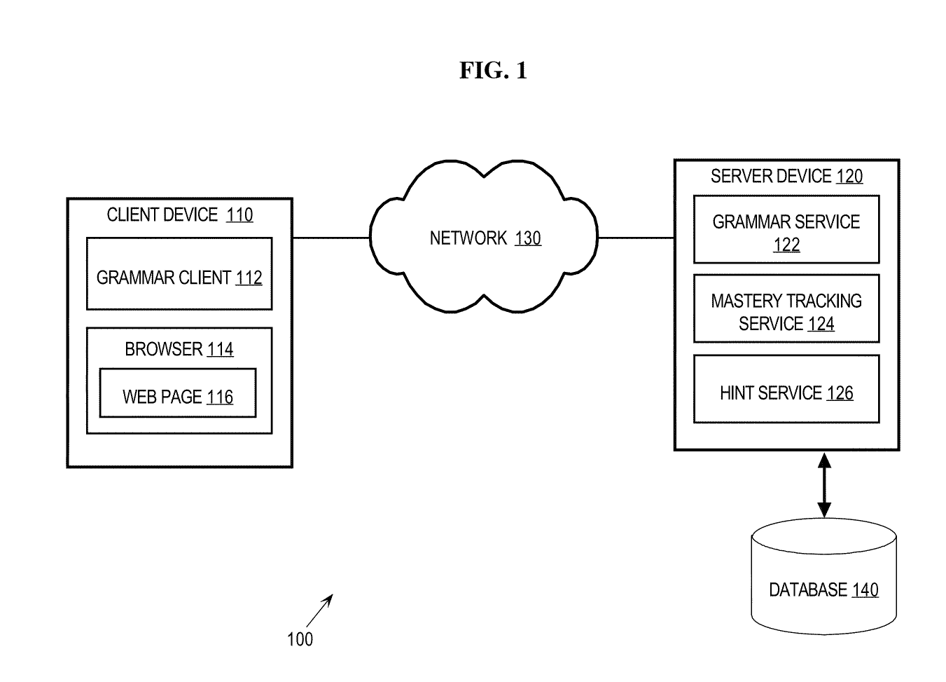

Techniques are described hereafter for adaptively instructing a user on grammar rules. FIG. 1 is a block diagram that depicts an example network arrangement 100 for an automated grammar teaching system that adaptively instructs a user regarding natural language grammar rules, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays a web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as a graphical user interface of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, a mastery tracking service 124, and a hint service 126. One or more of services 122-126 may be part of a cloud computing service. Functionality attributed to one or more of services 122-126 may be performed by grammar client 112, according to embodiments. Services 122-126 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-126 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-126 or grammar client 112. Further, any of grammar client 112 and services 122-126 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-126 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Grammar Skills

Grammar service 122 has access to a database of grammar problems in database 140. Grammar service 122 selectively display these problems to users. According to an embodiment, each grammar problem includes at least one sentence that has one or more grammar errors. Each grammar problem is configured such that identification and/or correction of the associated grammar error demonstrates one or more particular grammar skills Depending on the configuration of a particular problem, identification of a grammar error and correction of the grammar error may demonstrate different particular grammar skills Other aspects of a grammar problem may also be configured to facilitate demonstration of particular grammar skills within embodiments. A particular grammar problem is associated with at least those grammar skills that are demonstrated by correction and/or identification of the grammar errors in the one or more sentences of the particular grammar problem. According to another embodiment, one or more grammar problems in database 140 include no grammar errors.

To illustrate a grammar problem with a grammar error, a particular grammar problem in database 140 includes the following sentence: “People who like to dance lives longer.” The sentence has a subject-verb agreement error at “lives”, since the form of the verb “lives” does not agree with the form of the subject “people”. Correction of the grammar error in this sentence demonstrates a user's ability with respect to the grammar skill “subject-verb agreement”. As such, the particular grammar problem is associated with the grammar skill “subject-verb agreement”.

However, a grammar skill such as “subject-verb agreement” has many facets or granular grammar skills associated therewith, and may be considered a grammar skill topic. In other words, a user may have mastered a particular granular skill related to “subject-verb agreement” without having necessarily mastered a second granular skill related to “subject-verb agreement”. For example, mastering the grammar skill “subject-verb agreement” involves mastering the following more granular grammar skills:
“subject-verb agreement where there is intervening material between the subject and the verb”,
“subject-verb agreement where the subject is a compound subject”,
“subject-verb agreement where the subject follows the verb”, etc.

A user may have mastered “subject-verb agreement where there is intervening material between the subject and the verb” without necessarily having to master “subject-verb agreement where the subject is a compound subject”, and so on. According to an embodiment, grammar problems are associated (in database 140) with granular grammar skills instead of or in addition to one or more broad grammar skills (such as “subject-verb agreement”).

Furthermore, granular grammar skills—such as the granular grammar skills within the broader grammar skill of “subject-verb agreement”—may be further subdivided into grammar sub-skills. A grammar sub-skill is an even more specific facet of a granular grammar skill According to embodiments, at least some of the grammar problems in database 140 are associated with grammar sub-skills instead of or in addition to being associated with granular grammar skills.

For example, the granular grammar skill “subject-verb agreement where there is intervening material between the subject and the verb” may be further subdivided into the following six grammar sub-skills:
Subject-verb agreement where there is intervening material between a count noun subject and the verb (“Students who got a's on their test are eating in the park.”);
Subject-verb agreement where there is intervening material between a collective noun subject and the verb (“The team who won the big game is celebrating.”);
Subject-verb agreement where there is intervening material between a gerund phrase subject and the verb (“Running in the park on a sunny day is one of my favorite things to do.”);
Subject-verb agreement where there is intervening material between an indefinite pronoun subject and the verb (“Some of the students who got a's on their tests are celebrating.”);
Subject-verb agreement where there is intervening material containing an indefinite pronoun, which is not the subject of the sentence, between the subject and the verb (“The teacher that had most of the incidents of vandalism in her classroom has a lock on her door now.”); and
Subject-verb agreement where there is intervening material between a mass noun subject and the verb (“The peanut butter in the green jar was thrown away.”).
   According to an embodiment, grammar problems in database 140 that are related to grammar sub-skills are associated with both the grammar sub-skill and the related granular grammar skill

### Sentence Problems Stored at the Database

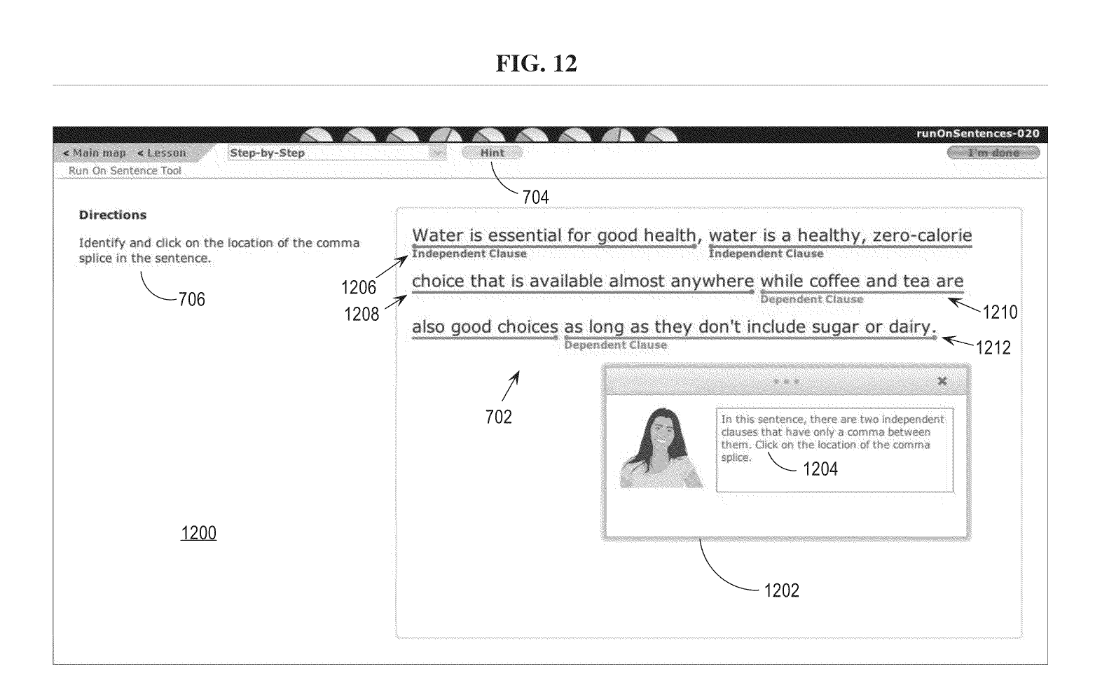

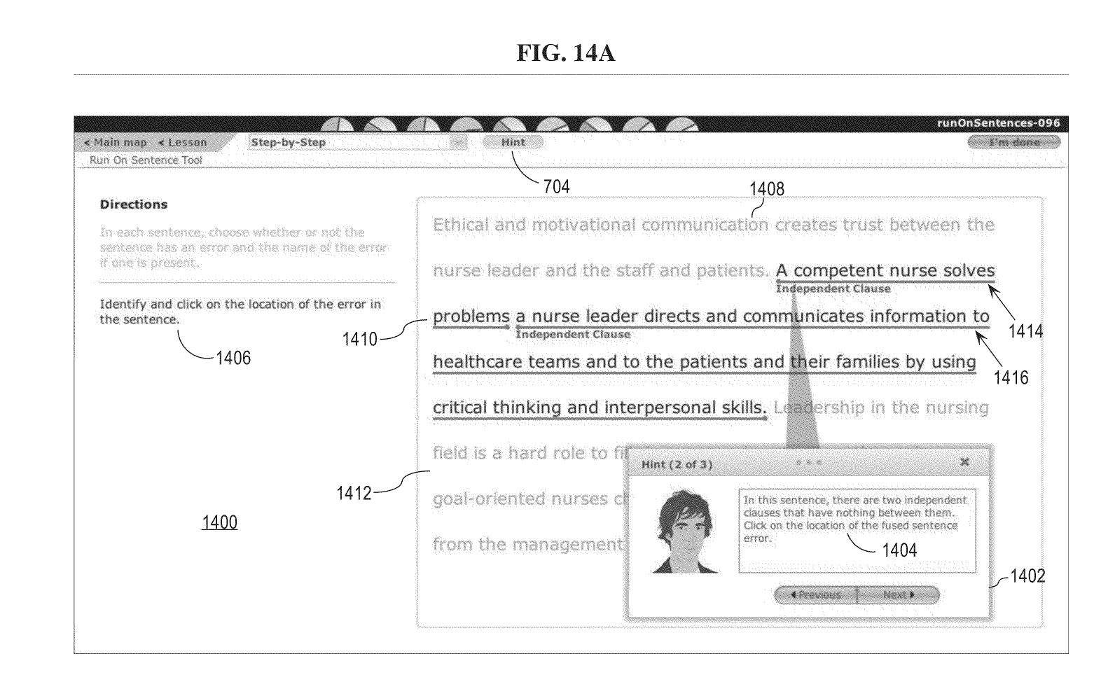

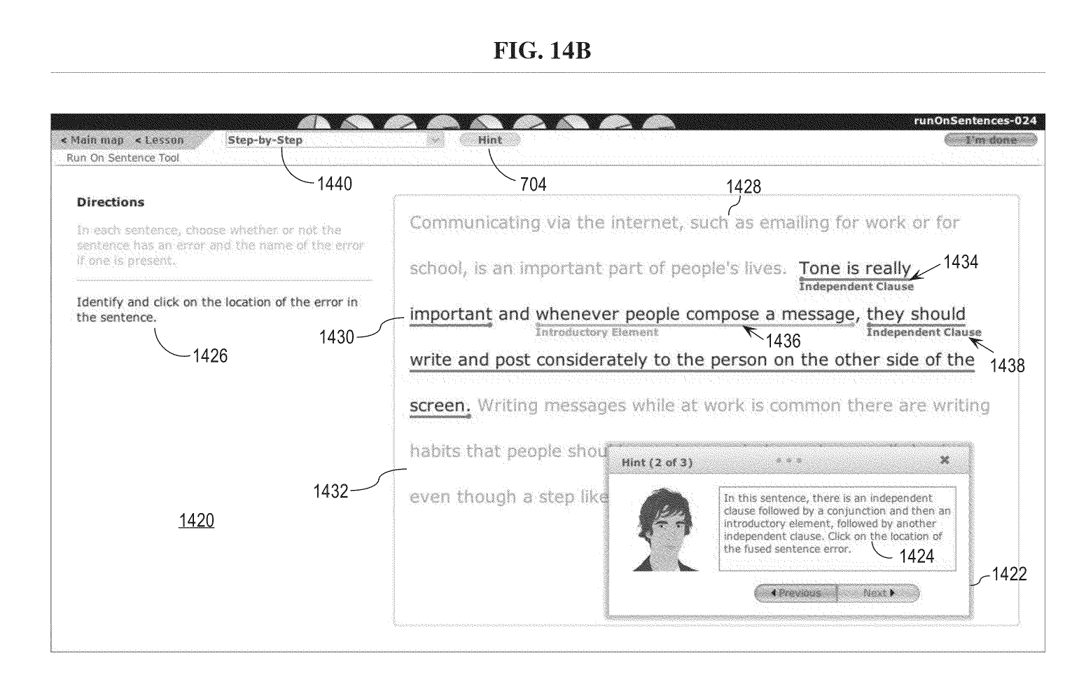

Database 140 stores a plurality of sets of grammar problem data. A particular set of problem data includes the data for a particular grammar problem that may be displayed to a user, e.g., at graphical user interface (GUI) 1200 of FIG. 12, at GUI 1400 of FIG. 14A, etc. Each grammar problem in database 140 includes a sentence with a grammar error, correction of which demonstrates mastery of one or more granular grammar skills of a plurality of granular grammar skills also stored at database 140. A grammar skill is a user's ability to correctly apply a particular natural language grammar rule.

According to embodiments, a grammar problem includes either (a) a single sentence (GUI 1200), or (b) two or more sentences configured to be displayed together (GUI 1400). A set of problem data also includes one or more of:
a type of a grammar error in a sentence for the problem (e.g., the broad grammar skill that correction of the error demonstrates, such as “subject-verb agreement”, or “run-on sentence”, etc.);
steps that a user must take to solve the problem (described in further detail below—e.g., a particular problem requires (step 1) location of the grammar error, and (step 2) correction of the error; and another problem requires (single step) reordering portions of a sentence to correct the error; etc.);
a location of a grammar error within a sentence for the problem (e.g., a unique identifier of a location within the sentence, a metadata marker of the location of the error in the sentence, etc.);
appropriate corrections for a grammar error in the problem (e.g., a list of words or phrases and/or punctuation that a user may input to correct the grammar error);
one or more grammar skills that (a) correction/location of an error in the problem demonstrates, (b) correct completion of a step of a grammar problem demonstrates, etc.;
remediation information regarding correct portions of a sentence (described in further detail below—e.g., information explaining why a particular comma within a sentence is correct);
information for hints relating to steps of the problem (described in further detail below);
metadata for a sentence (described in further detail below);
alternate wordings for a sentence (described in further detail below);
grammatical roles played by various portions of a sentence (described in further detail below);
a difficulty level (described in further detail below—e.g., for the problem, a step of the problem, etc.);
a set of sentences from which to choose the one or more sentences for the problem; etc.
   In an embodiment, one or more of the above data is stored in database 140, but not in connection with a set of problem data.

### Grammar Problem Steps

According to an embodiment, a set of problem data includes one or more steps that a user must take to complete the problem, which steps may be ordered or unordered. A particular grammar problem may have only one “step”. For example, a particular set of problem data indicates that a user must first identify the location of a grammar error within the problem sentence, and then correct the error within the sentence. According to embodiments, grammar skills associated with the grammar problem are associated with one or more steps of the problem. For example, a first problem step tests a user's mastery of a different granular grammar skill than a second problem step of the same problem, and as such, the first problem step is associated with a different granular grammar skill than the second problem step.

Example steps for a particular problem include the following:
Does the sentence include a grammar error?
Does the subject and verb of the sentence agree?
Where is the subject that the verb should agree with?
What is the form of the verb to make it agree?
How should be verb be changed to agree with the subject?
Where should you punctuate the sentence to fix a grammar error?
Enter in text to edit the sentence to fix the grammar error.

### Sentence Metadata

According to an embodiment, data for a grammar problem includes metadata for the grammar problem's sentence. For example, a particular set of problem data includes the following marked-up sentence (where metadata is embedded in the sentence): <_indepClause>Careers in healthcare administration continue to grow<_indepClause><_fusedSentence/><_indepClause>healthcare is a big business in the United States</_indepClause><_depClause>because it continues to create jobs and to hire more people.</_depClause>

Important components of the sentence's structure are tagged within the marked-up sentence, e.g., the independent and dependent clauses, and the grammar error in the sentence (at “<_fusedSentence/>”). Other types of sentence structure components may also be identified in sentence markup within embodiments, e.g., introductory elements, comma types, etc.

### Alternate Wordings Based on the Metadata

According to an embodiment, grammar service 122 creates a particular variation of the wording of a sentence for display to a user, using sentence metadata, at the time that grammar service 122 selects the problem data for display to the user. In this embodiment, the selected set of problem data includes metadata for the sentence indicating one or more wording variables positioned within a sentence and values that the one or more variables may assume.

According to another embodiment, grammar service 122 generates variations of the wording of a particular grammar problem's sentence, using the sentence metadata, prior to selecting the particular problem for display. For example, when grammar service 122 receives data for a grammar problem that includes a sentence with wording variables (as described above), grammar service 122 creates one or more versions of the problem data, each with a particular variation of the wording of the variable sentence. Such a generated version of the problem data does not include, in metadata for the sentence, wording variables because the wording variables have been resolved.

Continuing with the previous metadata example, the particular set of problem data includes the following marked-up sentence:

<_indepClause>$careers in healthcare administration continue to grow</_indepClause><_fusedSentence/><_indepClause>healthcare is a big business in the United States</_indepClause><_depClause>because it continues to create jobs and to $hire more people.</_depClause>

Grammar service 122 creates variations of the wording of this sentence by replacing the wording variables within the marked-up sentence (i.e., “$careers”, and “$hire) with alternative words or phrases. For example, the problem data includes the following definitions of the embedded variables: ‘careers’:RandomChoiceGenerator(choices=[‘Careers’, ‘Job prospects’, ‘Positions’]), ‘hire’: RandomChoiceGenerator(choices=[‘hire’, ‘employ’, ‘recruit’]). Based on the variable definitions, grammar service 122 creates the following sentence to display for a particular iteration of the grammar problem: “Job prospects in healthcare administration continue to grow healthcare is a big business in the United States because it continues to create jobs and to employ more people.”

Depending on the values with which grammar service 122 resolves wording variables in a sentence, the sentence may be made more or less complex. In an embodiment, the various words or phrases that are available to replace a particular variable are associated with respective difficulty levels. Grammar service 122 associates a difficulty level with a particular grammar problem based, at least in part, on a wording variable value used in the problem's completed sentence.

For example, a particular set of problem data stores the following wording variable metadata for the following sentence: “The child $interveningMaterial are going to school.” The variable, $interveningMaterial, is defined as ‘interveningMaterial’:RandomChoiceGenerator(choices=[‘whose parents work at the factory’, ‘with the toy’, “]). Each replacement value for the variable is associated with a different difficulty level, e.g., a number value between 1 and 10 (with 10 being the most difficult). Grammar service 122 produces the following three sentences from the marked-up sentence for three respective grammar problems, where the sentences are associated with the difficulty value of the intervening material that grammar service 122 chose to be in the sentence:
The child whose parents work at the factory are going to school. (Difficulty value of 8. Grammar service 122 associates this sentence with the grammar skill “subject-verb agreement with intervening material between subject and verb where the intervening material includes plural noun”.)
The child with the toy are going to school. (Difficulty value of 5. Grammar service 122 associates this sentence with the grammar skill “subject-verb agreement with intervening material between subject and verb”.)
The child are going to school. (Difficulty value of 2. Grammar service 122 associates this sentence with the grammar skill “subject-verb agreement”.)

According to an embodiment, metadata for a sentence includes one or more positions at which grammar service 122 may add or remove a comma for sentence variation. Such metadata may include a type of the subject comma, which grammar service 122 uses to produce remediation information, as described in further detail below.

According to an embodiment, metadata for a sentence includes a constraint on a quantity-type wording variable in the sentence. A quantity-type wording variable communicates a quantity. For example, metadata for a sentence indicates that a particular quantity-type wording variable within a sentence must be greater than zero and less than 20. According to embodiments, such constraints are dependent on the value of a second wording variable that is selected for the sentence. For example, a particular marked-up sentence includes two wording variables: “$subject”, and “$number” (a quantity-type variable), where ‘subject’:RandomChoiceGenerator(choices=[‘hats’, ‘books’]. The values associated with $subject each impose a different constraint on the $number variable. If $subject is replaced with “hats”, the constraint on $number is 1<$number<=20. If $subject is replaced with “books”, the constraint on $number is 1<$number<=150.

A particular set of grammar problem data in database 140 may include a plurality of sentences. According to embodiments, grammar service 122 selects one or more sentences, from the plurality of sentences, to display to the user for the particular set of grammar problem data. According to a particular embodiment, grammar service 122 follows constraints on ordering two or more selected sentences (i.e., in a paragraph to be displayed for the problem). For example, a constraint on ordering sentences for a grammar problem is “Do not start paragraph with a sentence that starts with “For example” “This” or “These”.”

According to an embodiment, grammar service 122 causes at least part of the metadata for a particular sentence to automatically be generated for a sentence based on information in database 140 for the sentence. For example, database 140 includes the following information about a particular sentence:

Sentence(text = ‘$InAddition, there is eight $stages of psychosocial development that people

$can go through.’,

phrases = [

Phrase(phraseType = ‘_subject’, text = ‘eight $stages of psychosocial development

that people $can go through’),

Phrase(phraseType = ‘_coreWord’, text = ‘$stages’),
Phrase(phraseType = ‘_verb’, text = ‘is’, fixType = ‘_thereIs’, fixes = [‘are’]),
Phrase(phraseType = ‘_otherVerb’, text = ‘$can’),
Phrase(phraseType = ‘_otherVerb’, text = ‘go’),
Phrase(phraseType = ‘_otherNoun’, text = ‘development’),
Phrase(phraseType = ‘_otherNoun’, text = ‘people’)],

subjNumber = ‘_plural’,
verbNumber = ‘_singular’)

Grammar service 122 generates the following sentence marked up with metadata based on the above information: “$InAddition, there <_verb>is</_verb><_subject>eight <_coreWord>$stages</_coreWord> of psycho social <_otherNoun>development</_otherNoun> that <_otherNoun>people</_otherNoun><_otherVerb>$can</_otherVerb><_otherVerb>go</_otherVerb>through</_subject>.”

### Tracking Grammar Skill Mastery

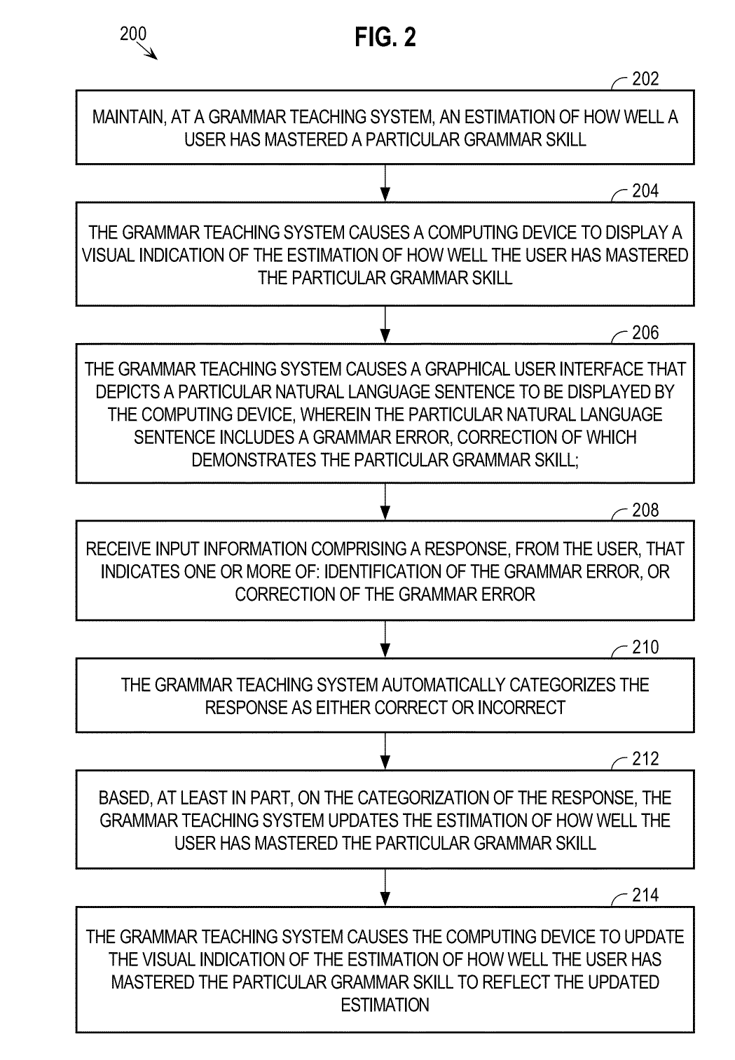

By working the problems presented to a user by the automated grammar teaching system of FIG. 1, a user may increase the user's mastery of the grammar skills taught by the system. FIG. 2 depicts a flowchart 200 for tracking and displaying a user's mastery estimate for a particular grammar skill, which represents the probability that a user has mastered the particular grammar skill.

At step 202, a grammar teaching system maintains a user-specific, skill-specific mastery estimate. Mastery of a particular granular grammar skill is not equivalent to correctly answering the steps of a problem associated with the grammar skill. In other words, the fact that a user correctly answers a step of a problem does not mean that the user has mastered the grammar skills associated with the problem step. A user has 100% mastery of a grammar skill when the user fully understands and can fully apply the rules of grammar governing the grammar skill.

As an example of step 202, mastery tracking service 124 maintains, at database 140, a mastery estimate for a particular user for a particular granular grammar skill Mastery tracking service 124 saves a user's mastery estimate at database 140, e.g., in a user profile for the user. A mastery estimate may represent, for example, a calculated probability of the user having mastered the associated grammar skill Mastery estimates may be recorded in database 140 as a percentage (where 100% is a perfect mastery estimate), as a score on a 10-based scale (where 10 is perfect mastery), as a score on a 1.0 based-scale, etc.

According to an embodiment, mastery tracking service 124 maintains separate mastery estimates for the sub-skills of a granular grammar skill According to another embodiment, mastery tracking service maintains mastery estimates for granular grammar skills and does not track estimated mastery for sub-skills. In this embodiment, user input for grammar problems that are related to the sub-skills of a particular granular grammar skill is counted toward the mastery estimate for the particular granular grammar skill.

The estimation of how well a user has mastered a particular grammar skill stored at database 140 may be newly initialized by mastery tracking service 124, or mastery tracking service 124 may calculate the grammar estimate based, at least in part, on performance of the user on problems presented by grammar service 122 (as described in further detail below). A newly initialized mastery estimate may serve as a “prior mastery value” for the mastery estimation algorithm described in further detail below.

According to an embodiment, mastery tracking service 124 initializes the user's mastery estimate for a particular grammar skill using a general estimate of what an average student knows about the particular grammar skill before completing problems with grammar service 122. In this embodiment, mastery tracking service 124 assigns, to the mastery estimate for the particular grammar skill, an initial grammar mastery estimate that is not user-specific. For example, mastery tracking service 124 retrieves, from database 140, an initial mastery estimate of 25% for the particular grammar skill, and initializes a user's mastery estimate for that particular grammar skill with the retrieved initial value.

According to another embodiment, mastery tracking service 124 initializes a user's mastery estimate for a particular grammar skill based on diagnostic information submitted by the user. For example, grammar service 122 provides a particular user with a diagnostic quiz that includes questions that are configured to elicit information about the user's knowledge of the grammar skills that are targeted by grammar service 122. Mastery tracking service 124 analyzes particular answers, submitted by the user, related to a particular grammar skill to create an initial estimate of how well the user has mastered the particular grammar skill.

As another example of initializing a user's mastery estimate for a particular grammar skill based on diagnostic information submitted by the user, grammar service 122 initializes one or more of a user's mastery estimates based on an analysis of a writing sample from the user. Mastery tracking service 124 receives analysis information analyzing the grammar usage in a user's writing sample, e.g., from a third-party grammar analysis engine. Such analysis information may include quantities and types of grammatical errors in the writing sample.

According to an embodiment, mastery tracking service 124 counts each grammatical error in a writing sample, or each wrong answer on a diagnostic quiz, relating to a particular grammar skill as an incorrect answer on a grammar problem presented by grammar service 122 in estimating the user's initial mastery of the particular grammar skill Thus, as with answers submitted through grammar service 122, mastery tracking service 124 uses techniques from the theory of Bayesian Knowledge Tracing (described in further detail below) to calculate the initial user's mastery estimate for the particular grammar skill.

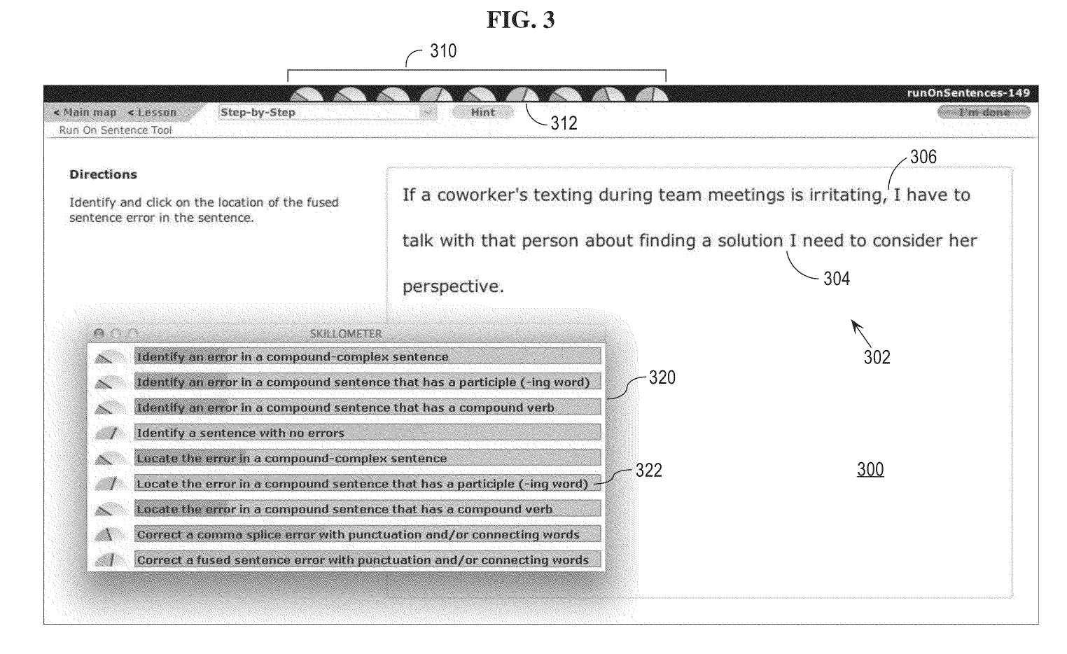

At step 204, the grammar teaching system causes a computing device to display a visual indication of the mastery estimate for the particular grammar skill For example, in FIG. 1, web page 116 includes a graphical user interface such as GUI 300 of FIG. 3, which is generated by grammar service 122 executing on server device 120 or by grammar client 112 executing on client device 110. Grammar service 122 sends information for GUI 300, via network 130, to grammar client 112. Grammar client 112 makes GUI 300 available to browser 114 executing on client device 110, and browser 114 displays GUI 300, i.e., in web page 116. According to another embodiment, grammar client 112 causes GUI 300 to be displayed outside of a browser, e.g., as part of a stand-alone application.

GUI 300 includes a plurality of visual indications of mastery estimates (i.e. visual indications 310 and expanded visual indications 320). Visual indications 310 are shorthand representations of expanded visual indications 320, and each of visual indications 310 correspond with an expanded visual indication of visual indications 320. For example, visual indication 312 shows a 60% mastery, which corresponds to the 60% mastery shown in visual indication 322 for the grammar skill “correct a fused sentence error with punctuation and/or connecting words”.

According to an embodiment, visual indications 310 and 320 include indications for those granular grammar skills that are related to a broad grammar skill, which is a topic on which the user is currently working within the grammar teaching system. In the example of GUI 300, the displayed visual indications are for granular grammar skills that are all facets of the broad grammar skill “run-on sentences”. A user summons visual indications 320 by clicking anywhere on visual indications 310. A user may hide visual indications 320 by closing the window housing visual indications 320.

In the embodiment of GUI 300, visual indication 312 is in the style of a dial, where the midline of the dial is positioned according to the mastery estimate for the associated granular grammar skill. Furthermore, visual indication 312 is colored with a color that communicates the height of the mastery estimate score for the related grammar skill. For example, visual indications showing low mastery estimates are colored red or dark orange (0%-25%); visual indications showing mid-range mastery estimates are a lighter orange (25%-75%); visual indications showing mastery estimates that are close to “mastered” are yellow (75%-95%); and visual indications showing “mastered” are green (95%-100%). Any color scale and range amounts may be used within embodiments.

At step 206, the grammar teaching system causes a graphical user interface that depicts a particular natural language sentence to be displayed by the computing device, wherein the particular natural language sentence includes a grammar error, correction of which demonstrates the particular grammar skill To illustrate, GUI 300 depicts a natural language sentence 302 that includes a grammar error at location 304. Specifically, the sentence is an incorrect fused sentence because the independent clause “I need to consider her perspective” is concatenated with the rest of the sentence without any appropriate connecting punctuation or conjunction (such as “, and”). According to an embodiment, problem data for sentence 302 includes information identifying location 304 as being between words 19 and 20 within sentence 302 (or word-based location 19.5). The grammar error is associated with the grammar skill “locate the error in a compound sentence that has a participle (-ing word)” because identification of the displayed grammar error, as instructed in GUI 300, demonstrates this grammar skill.

At step 208, input information comprising a response is received from the user, the response indicating one or more of: identification of the grammar error, or correction of the grammar error. To identify a location of a grammar error within a sentence, a user may click on a particular location within a graphical representation of the sentence, move a cursor and select a particular location within a displayed sentence with a key stroke, drag an editable text box (or other visual control) to a particular location within the display of the sentence, etc. For example, GUI 300 instructs the user to identify and click on the location of the fused sentence error in the displayed sentence 302. Grammar client 112 receives information indicating a location of the user's click within the display of sentence 302.

To allow a user to correct a grammar error within a sentence, grammar service 122 may perform one or more of the following: provide one or more editable text boxes at one or more locations within a sentence; provide one or more editable text boxes that a user may drag to one or more locations within the sentence; allow the user to move portions of the sentence around within the sentence; etc. Grammar client 112 receives information indicating the user's correction via the provided mechanism.

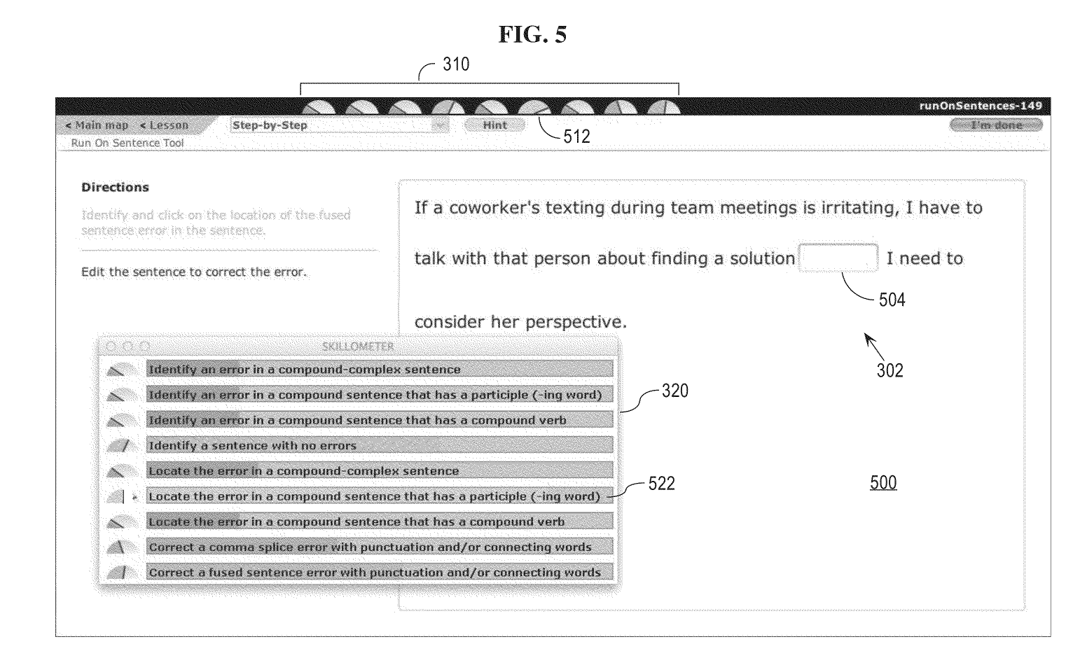

According to an embodiment, grammar service 122 automatically provides the appropriate answer mechanism in connection with the appropriate step of a problem, as with text box control 504 in GUI 500 of FIG. 5. According to another embodiment, grammar service 122 provides the user with multiple answer mechanisms and allows the user to choose the answer mechanism and/or where to locate the answer mechanism. In this embodiment, a user must decide how best to fix a grammar error in a sentence.

Based on the nature of the grammar error, it is possible that there is only one right type of correction, and it is possible that multiple types of error corrections would work. For example, in a sentence with a “parallel structure” grammar error, a user may be required to identify items that should be in parallel within the sentence, and then correct the errors that prevent the items from being presented in parallel. Generally, with these kinds of grammar errors, there are multiple ways of correcting the error. Giving the user the option to choose a manner of correction shows the user that there may be multiple ways to perform the correction, since writing is dynamic. Embodiments include any combination of grammar service 122 automatically providing the user with an answer mechanism and allowing the user to choose from a plurality of possible answer mechanisms.

At step 210, the grammar teaching system automatically categorizes the response as either correct or incorrect. For example, grammar client 112 receives information that the user clicked on location 306 in GUI 300. Grammar client 112 identifies location 306 as word-based position 8.5 within the structure of natural language sentence 302. According to an embodiment, grammar client 112 classifies anything between words 8 and 9 of sentence 302 (including the comma and the white space) to be at location 8.5 within the structure of sentence 302.

At least some grammar problems are designed to elicit common grammar misconceptions, and include information that indicates how a student might respond to a step in a manner that demonstrates a lack of the associated grammar skill From the problem data for sentence 302, grammar client 112 determines that location 306 is not the location of the grammar error within the sentence (i.e., location 304). As such, grammar client categorizes the response as incorrect.

For another example, grammar client 112 receives information that the user clicked on location 304 within sentence 302 in GUI 300 (or word-based location 19.5). From the problem data for sentence 302, grammar client 112 determines that the user clicked on the correct location of the grammar error.

At step 212, based, at least in part, on the categorization of the response, the grammar teaching system updates the mastery estimate for the particular grammar skill. For example, grammar client 112 sends the classification of the user's answer for the current step of the problem associated with sentence 302 to grammar service 122. Grammar service 122 then causes mastery tracking service 124 to calculate a mastery estimate of the probability of how well the user has mastered the one or more grammar skills associated with the current step of the current problem (i.e., “locate the error in a compound sentence that has a participle (-ing word)”, the mastery estimate for which is displayed at visual indications 312 and 322).

According to an embodiment, a user's mastery estimate for grammar sub-skills is explicitly and individually tracked, and the user's mastery estimate of a granular grammar skill related to the grammar sub-skills is calculated based on the mastery estimates of the grammar sub-skills, as well as any mastery estimate separately calculated for the granular grammar skill. For example, in this embodiment, grammar problems or steps of grammar problems are either associated with grammar sub-skills or the granular grammar skill associated with the grammar sub-skills. As such, user input may be related to sub-skills or directly to the granular grammar skill itself.

According to another embodiment, grammar service 122 does not distinguish between sub-skills of a particular granular grammar skill and the particular granular grammar skill itself with respect to mastery estimations. In this embodiment, user input received in connection with a grammar problem step that is associated with a sub-skill of a particular granular grammar skill is counted as relating to the particular granular grammar skill. In this embodiment, a sub-skill may easily be elevated to the level of granular grammar skill, since the sub-skill is identified separately within the grammar problems of database 140.

Given the user input, mastery tracking service 124 updates the estimation of whether the user has mastered the associated granular grammar skill—i.e., “locate the error in a compound sentence that has a participle (-ing word)”—using Bayesian Knowledge Tracing. See Corbett, J. Anderson (1995). “Knowledge tracing: Modeling the acquisition of procedural knowledge”. User Modeling and User-Adapted Interaction. 4 (4): 253-278, which is incorporated by reference as if fully set forth herein.

For example, mastery tracking service 124 uses the following Equation 1 to update the probability that a user has mastered the granular grammar skill:

$${Y}_{n} = {Y}_{n - 1} + \frac{L ( 1 - {Y}_{n - 1} [ 1 - S ] )}{L ( 1 - {Y}_{n - 1} [ 1 - S ] ) + G ( 1 - {Y}_{n - 1} )} \qquad Eq . 1$$

In one of the above examples, the user clicked on the incorrect location of the grammar error within sentence 302 (i.e., location 306). Based on Equation 1 and given the prior mastery estimate for the granular grammar skill indicates a 60% probability that the user has mastered the granular grammar skill, mastery tracking service 124 determines that the updated mastery estimate for the granular grammar skill is a 50% probability of mastery.

In another of the above examples, the user clicked on the correct location 304 within sentence 302. Based on Equation 1 and given the prior mastery estimate for the granular grammar skill indicates a 60% probability that the user has mastered the granular grammar skill, mastery tracking service 124 determines that the updated mastery estimate for the granular grammar skill is a 89.7% probability of mastery.

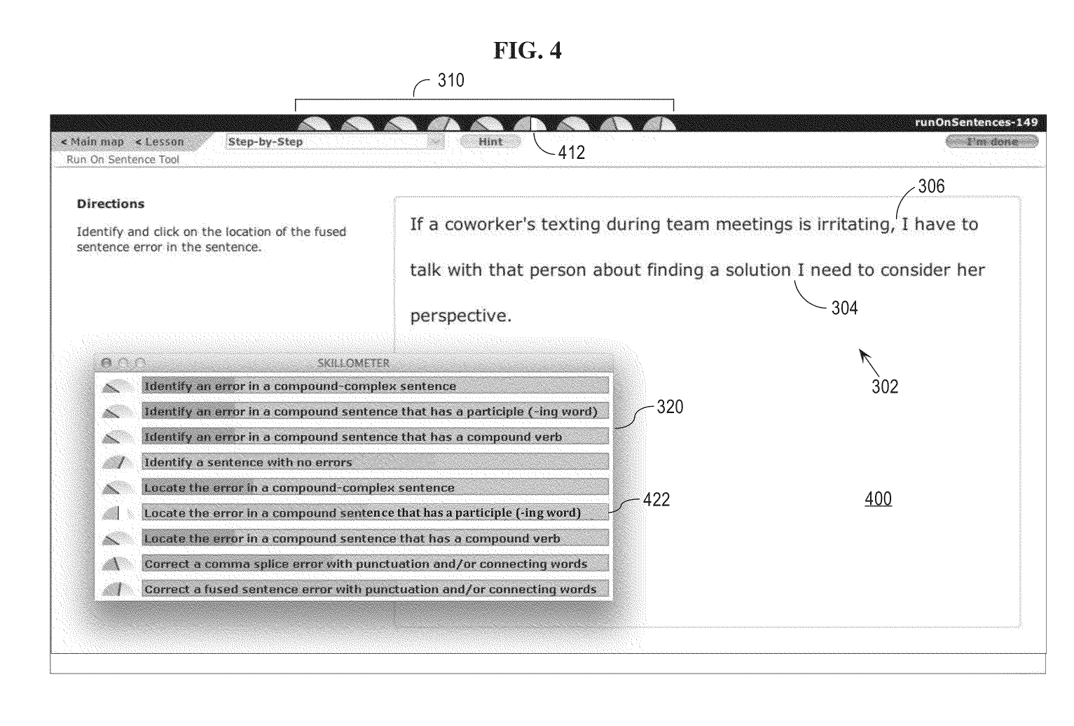

At step 214, the grammar teaching system causes the computing device to update the visual indication of the mastery estimate for the particular grammar skill to reflect the updated estimation. To illustrate in context of the example above in which the user input was incorrect and the updated mastery estimate for the granular grammar skill is 50%, grammar client 112 receives information indicating the updated mastery estimate and causes GUI 400 of FIG. 4 to be displayed.

In GUI 400, grammar client 112 displays the same step of the grammar problem for sentence 302 as is displayed in GUI 300 since the user answered the step incorrectly. According to embodiments, grammar client 112 also reiterates the instructions to the user, e.g., by highlighting the instructions, by displaying information indicating why the user was incorrect, by displaying information about why the portion of sentence 302 was correct (described in more detail below), by showing hint information for the problem step (also described in more detail below), etc. Furthermore, in GUI 400, grammar client 112 causes visual indications 412 and 422 to reflect the updated mastery estimation (of 50%) for the granular grammar skill “locate the error in a compound sentence that has a participle (-ing word)”.

Furthermore, in the context of the example above in which the user input was correct, grammar client 112 receives the information indicating that the updated mastery estimate for the granular grammar skill is 85%. In GUI 500 of FIG. 5, grammar client 112 causes the next step of the grammar problem for sentence 302 to be displayed because the user correctly answered the step depicted in GUI 300. Specifically, GUI 500 now instructs the user to edit the sentence to correct the error, i.e., by entering text in text box control 504. Visual indications 512 and 522 of GUI 500 reflect the updated mastery estimate (of 85%) for the granular grammar skill “locate the error in a compound sentence that has a participle (-ing word)”.

### Remediation Information

According to an embodiment, in response to categorizing a user's response as incorrect, grammar service 122 determines if the incorrect response demonstrates commission of one of a set of “common errors” made by users. Grammar client 112 presents remediation information in response to such a commission of a common error. The remediation information is context- and input-specific. For example, grammar client 112 displays a natural language sentence with two verbs and instructions to click on the verb that needs to match the subject. If the user clicks on the wrong verb, grammar client 112 identifies this as a “common error” for which grammar client 112 has remediation information in database 140 to display. As such, grammar client 112 displays the following remediation information from database 140: “You have identified a verb, but not the verb that needs to match the subject.” Display of such remediation information aids the user to identify the mistakes that the user is making, and may help the user to learn from the incorrect answer.

According to an embodiment, grammar client 112 identifies the “common error” based on metadata for the sentence in the grammar problem data. For example, the sentence above includes one or more embedded metadata tags that identify the verb that does not need to match the subject of the sentence. Grammar client 112 identifies remediation information to display to the user by matching the metadata tag to remediation information in (a) the problem data or (b) in a remediation data store in database 140. Remediation information in a remediation data store in database 140 may include wording variables that are filled with information from the problem data prior to display in connection with the problem data.

Furthermore, users can provide answers to questions that are not correct in the context of the current step of the currently displayed problem, but that do not necessarily display a lack of mastery of a related grammar skill. For example, a student submits an answer to a problem step that could make sense in the situation, given the topic, but that does not strictly follow instructions given by grammar client 112. According to an embodiment, grammar client 112 does not count such an answer as incorrect for the purposes of estimating mastery for the related grammar skill. In this embodiment, the visual indication of the mastery estimate for the related grammar skill does not update after receiving the incorrect response since the mastery estimate does not change.

To illustrate, grammar client 112 displays the following sentence and instructs the user to identify (and click on) the core noun that determines whether or not the verb is plural or singular: “Some of the cake are gone.” The core noun that grammar client 112 expects the user to click on is “the cake”. However, if a user clicks on “some”, the user has identified an indefinite pronoun that is, in fact, the subject of the sentence. Thus, the user has clicked on the subject of the sentence instead of the “core noun”. Because the answer does not show that the user lacks understanding of the structure of the sentence, grammar client 112 does not count the answer as incorrect with respect to related grammar skill mastery estimates.

According to an embodiment, database 140 includes remediation information for grammar client 112 to display for such mistakes. For example, when grammar client 112 detects the user input that selects “some” in the sentence above, grammar client 112 determines whether there is remediation information to display to the user. Such determination is based on remediation rules that identify when such remediation information should be displayed and which exact remediation information should be displayed in the current situation. In this example, grammar client 112 displays the following remediation information: “Some is the core noun, but you need to determine what word that determines whether the verb is singular or plural.”

### Adaptive Hints

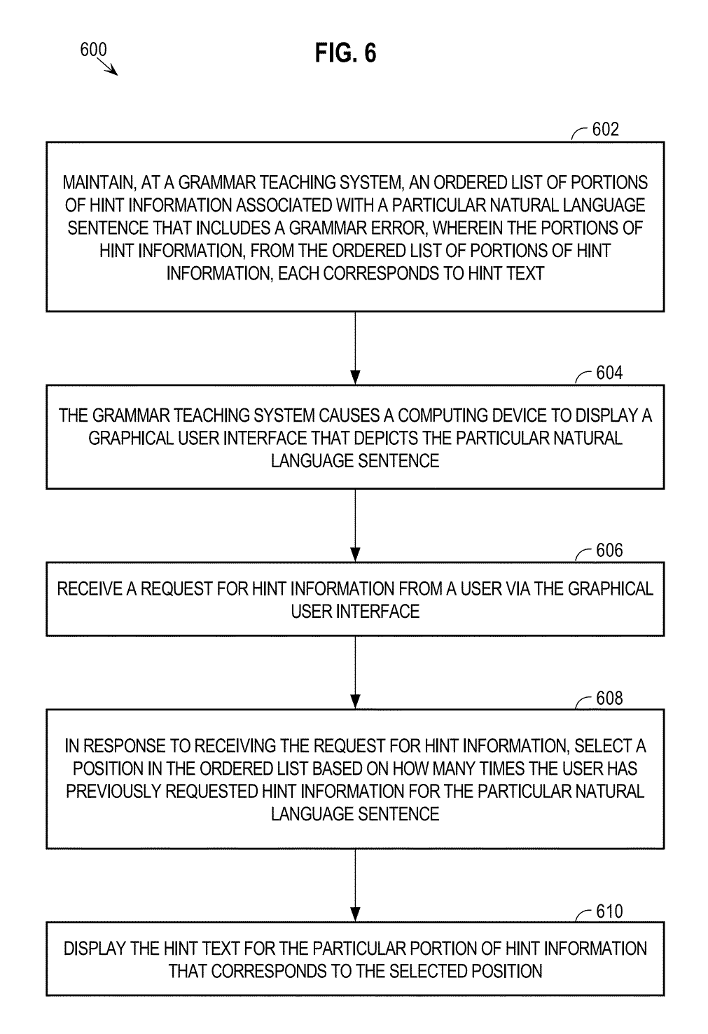

At each step of a particular grammar problem, a user may request a hint related to the current step of the problem. The hint is configured to help the user understand and conceptualize the required response for the current step. FIG. 6 depicts a flowchart 600 for displaying a hint from an ordered list of hint information in response to a request for hint information from a user.

At step 602, a grammar teaching system maintains an ordered list of portions of hint information associated with a particular natural language sentence that includes a grammar error, wherein the portions of hint information, from the ordered list of portions of hint information, each corresponds to hint text. For example, database 140 of FIG. 1 includes, for each set of problem data, an ordered list of two or more portions of hint information. According to an embodiment, a particular ordered list of portions of hint information is associated with a particular step of a particular problem.

A portion of hint information corresponds to hint text to be displayed to a user. According to an embodiment, a particular portion of hint information includes the hint text. According to another embodiment, a particular portion of hint information identifies hint text stored at database 140, i.e., with a unique hint text identifier. According to another embodiment, a particular portion of hint information identifies, i.e., with a hint template identifier, a hint text template from which hint text for the particular portion of hint information may be constructed, as described in further detail below. The hint text for a particular portion of hint information communicates information to aid a user in completing the related step of the grammar problem.

### The Ordered List of Portions of Hint Information

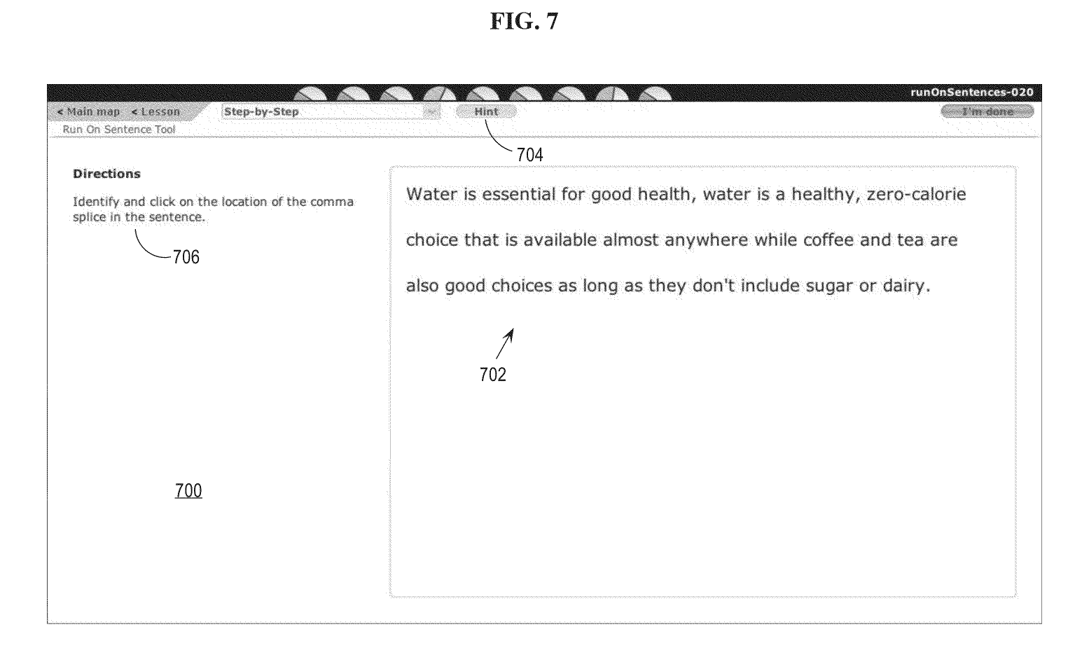

According to an embodiment, portions of hint information are ordered, within the ordered list, based on specificity of the hint text for the information portions. As a non-limiting example, a first portion of hint information includes additional details about instructions for answering the current step in the current problem. To illustrate, such a “least detailed” portion of information includes more detailed directions than is included in directions presented with the problem's one or more natural language sentences. FIG. 7 depicts a GUI 700 that includes a natural language sentence 702 and directions 706 to instruct the user as to what the user must do to complete the current step of the problem for sentence 702.

A second portion of hint information in the ordered list includes further information about the nature of the needed correction, about the grammar error to be located, about the structure of the displayed natural language sentence, etc. Such further information may include information about grammatical structures within the displayed natural language sentence (i.e., sentence 702 of GUI 700). To illustrate, such a “moderately detailed” portion of information informs the user about independent clauses, dependent clauses, introductory elements, etc., within sentence 702.

A third portion of hint information in the ordered list gives the user at least one of a set of one or more possible correct answers to complete the current step of the current problem. For example, such a “most specific” portion of hint information visually highlights a location of a grammar error within the displayed natural language sentence, displays text that the user could input to correct a grammar error within the displayed natural language sentence, etc.

According to an embodiment, a particular step in a grammar problem is associated with two or more sets of ordered portions of hint information. Hint service 126 selects a particular set of the two or more sets of ordered portions of hint information for display to a user based, at least in part, on criteria associated with the sets of hint information.

For example, in a step of a grammar problem associated with the grammar skill Subject-Verb Agreement, a user may identify first either the subject of a sentence in the grammar problem or a verb in the sentence. The grammar problem step is associated with a first set of hint information associated with the criteria that the user selects the subject of the sentence first and a second set of hint information associated with the criteria that the user selects a verb of the sentence first.

In response to a request for hint information for the grammar problem step, hint service 126 determines which set of hint information to display to the user based on the criteria for the sets of hint information. In the example grammar problem stem, if hint service 126 determines that the user has chosen to select the subject first, then hint service 126 identifies the first set of ordered portions of hint information for display to the user since the criteria for that set of hint information is that the user selects the subject of the sentence first. Alternatively, if hint service 126 determines that the user has chosen to select a verb first, then hint service 126 identifies the second set of ordered portions of hint information for display to the user since the criteria for that set of hint information is that the user selects a verb of the sentence first.

### Displaying Hint Information

At step 604, the grammar teaching system causes a computing device to display a graphical user interface that depicts the particular natural language sentence. For example, grammar client 112 displays GUI 700 of FIG. 7. GUI 700 includes natural language sentence 702 that has a grammar error. Natural language sentence 702 is part of a particular set of grammar problem data from database 140 (i.e., retrieved by grammar service 122, which sends at least part of the problem data to grammar client 112 for display and/or further processing).

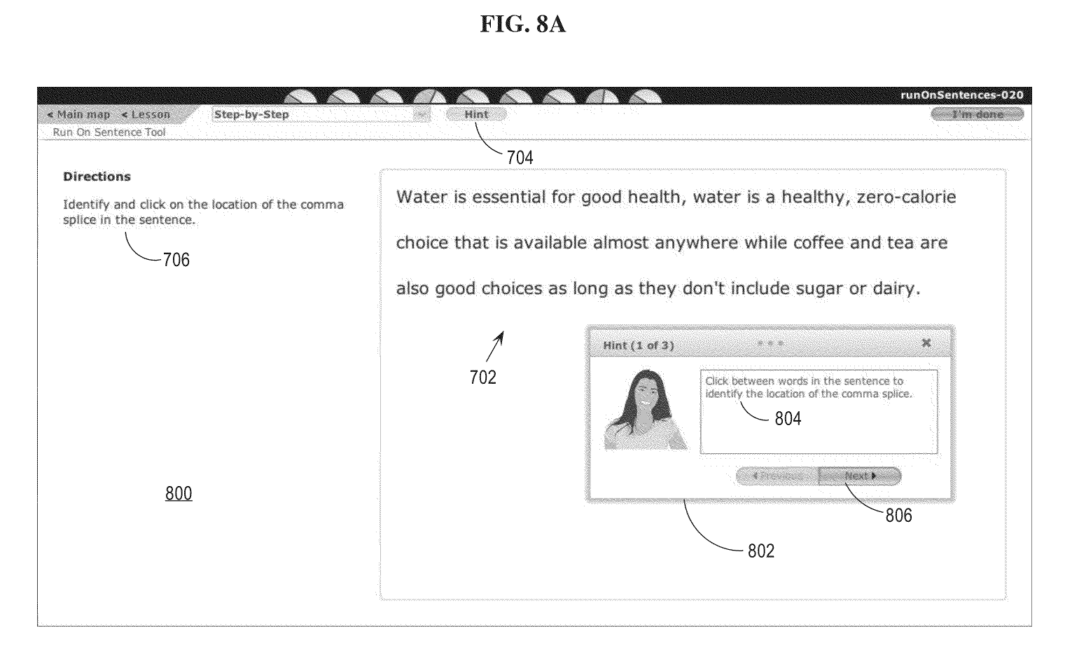

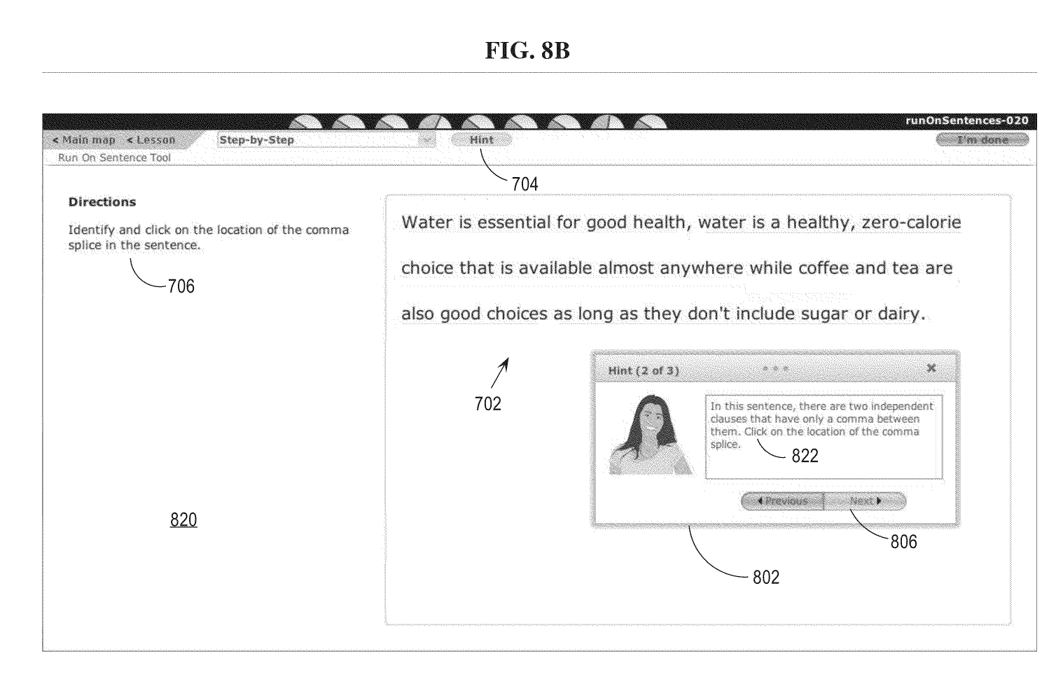

At step 606, a request for hint information is received from a user via the graphical user interface. For example, GUI 700 includes a hint button 704. Grammar client 112 detects that the user has activated hint button 704 and interprets that activation as a request for hint information from the user. A user may request hint information in other ways within embodiments. For example a user may activate next button 806 of GUI 800 (FIG. 8A) and grammar client 112 interprets information indicating such activation as a request for hint information from the user.

At step 608, in response to receiving the request for hint information, a position in the ordered list is selected based on how many times the user has previously requested hint information for the particular natural language sentence. For example, hint service 126 maintains historical information indicating how many times a user has requested hint information for the current step of the current problem, i.e., via mechanisms indicated above. According to an embodiment, hint service 126 maintains a record of how many times a user has requested hint information for the current step of the current grammar problem until the user completes that step. Once the user completes the step, hint service 126 tracks a number of times the user has requested hint information for the next step, without regard to a number of times the user requested information for the previous step.

In response to receiving the request for hint information, grammar client 112 sends the request to hint service 126. Hint service 126 identifies a position in the ordered list of portions of hint information for the current grammar problem step based, at least in part, on the historical information indicating the number of times that the user has previously requested hint information for the current step. For example, if the user has not yet requested hint information for the current step of the problem, hint service 126 selects the first position in the ordered list of portions of hint information. As another example, if the user has previously requested hint information two times for the current step, hint service 126 select the third position in the ordered list.

With respect to the example grammar problem of GUI 700, it is the first time that the user has requested hint information for the displayed step of the grammar problem for natural language sentence 702. Therefore, hint service 126 selects the first position of hint information in an ordered list of portions of hint information associated with the current step.

In an embodiment, if a particular step of a particular problem is not associated with an ordered list of hint information, then hint service 126 responds to a request for hint information for the particular step with generic hint information. If such generic hint information is in an ordered list, then hint service 126 selects a position for the portion of generic hint information to display as described above.

At step 610, the hint text for the particular portion of hint information that corresponds to the selected position is displayed. For example, FIG. 8A depicts a GUI 800 that represents the state of GUI 700 after the user activates hint button 704. Grammar client 112 causes hint control 802 to be displayed. Hint control 802 displays the hint text 804 for the first portion of hint information selected by hint service 126, which is “Click between words in the sentence to identify the location of the comma splice.” According to an embodiment, this first portion of hint information gives additional details about the instructions for the current grammar problem step.

Hint service 126 records the request for hint information in historical information for the user, e.g., in a user profile, in a variable for the user at grammar client 112, etc. Since this is the first request for hint information for the current step, the historical information indicates one historical request for hint information for the current grammar problem step.

### Hint Templates

According to an embodiment, hint service 126 constructs hint text for a particular portion of hint information based, at least in part, on a hint template. A hint template may be used for hint information that is not part of an ordered list. For example, database 140 stores hint templates that are identified using unique hint template identifiers. The problem data for a particular problem includes an identifier of a hint template as the hint text for a particular portion of hint data, e.g., in an ordered list. As another example, database 140 stores hint templates based on one or more of: the type of a current grammar problem step, the type of grammar error, etc. In this example, hint service 126 identifies a hint template for hint information to be displayed based, at least in part, on information from the corresponding grammar problem step.

According to an embodiment, in response to receiving a request for hint information, hint service 126 constructs the hint text for the appropriate portion of hint information based, at least in part, on a hint template identified for the portion of hint information. According to another embodiment, hint service 126 constructs hint text for a portion of hint information from an identified hint template prior to receiving a request that requires display of the portion of hint information.

A hint template includes one or more placeholders. To construct hint text using a hint template, hint service 126 fills the one or more placeholders in the hint template with information from the corresponding grammar problem step. The following is an example hint template: “This sentence can be corrected by entering <_problemStep.sentenceCorrections[0]/>.”. The placeholder in the template is “<_problemStep.sentenceCorrections[0]/>”. This placeholder refers to the first item of an array of sentence corrections (sentenceCorrections) for the current grammar problem's current step (_problemStep). When hint service 126 constructs hint text based on this template, hint service 126 looks up the first item of the sentenceCorrections array for the current problem step and inserts the value of that first item (e.g., “, and”) into the place of the placeholder. This results in the following hint text: “This sentence can be corrected by entering, and.”

### Displaying Multiple Portions of Hint Information

After requesting the first portion of information, a user may activate next button 806 of GUI 800 (FIG. 8A) to request an additional portion of hint information from grammar service 122. Further, a user may activate hint button 704 (e.g., after dismissing hint control 802) to request an additional portion of hint information.

To illustrate requesting additional hint information, the user activates next button 806 in GUI 800. In response to this button activation, help service 126 selects the second position within the ordered list of portions of help information for the current step based on the historical information saved for the user. As indicated above, the historical information for the user indicates one historical request for hint information for the current grammar problem step. Grammar client 112 displays GUI 820 of FIG. 8B with the help text 822 from the second portion of help information from the ordered list of portions of help information for the current grammar problem step.

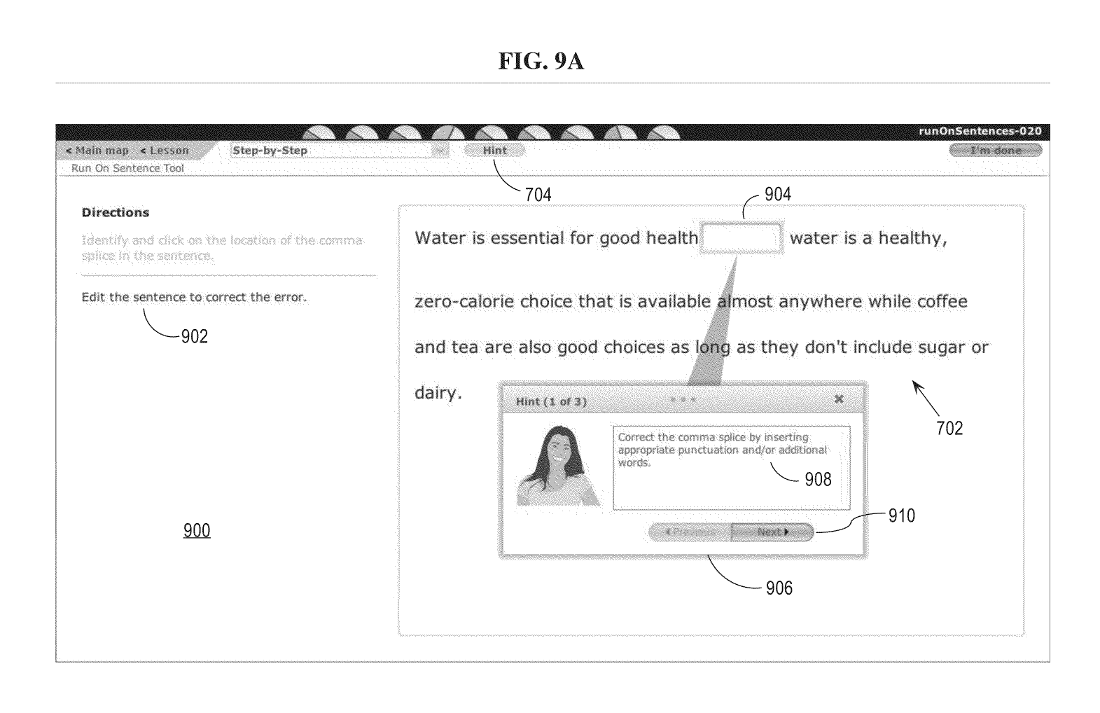

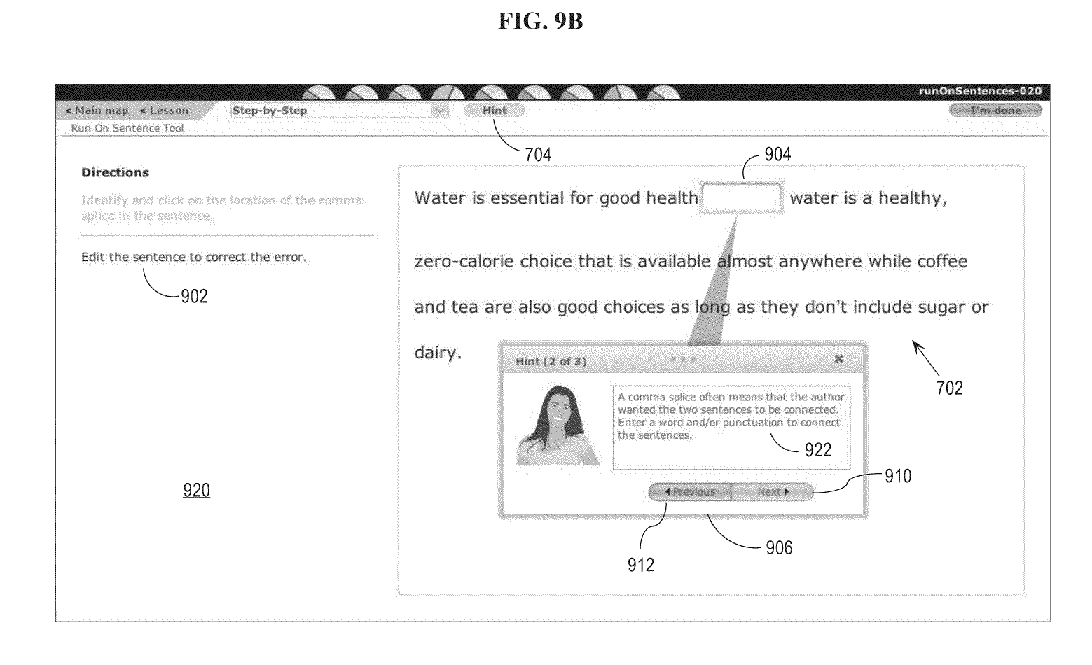

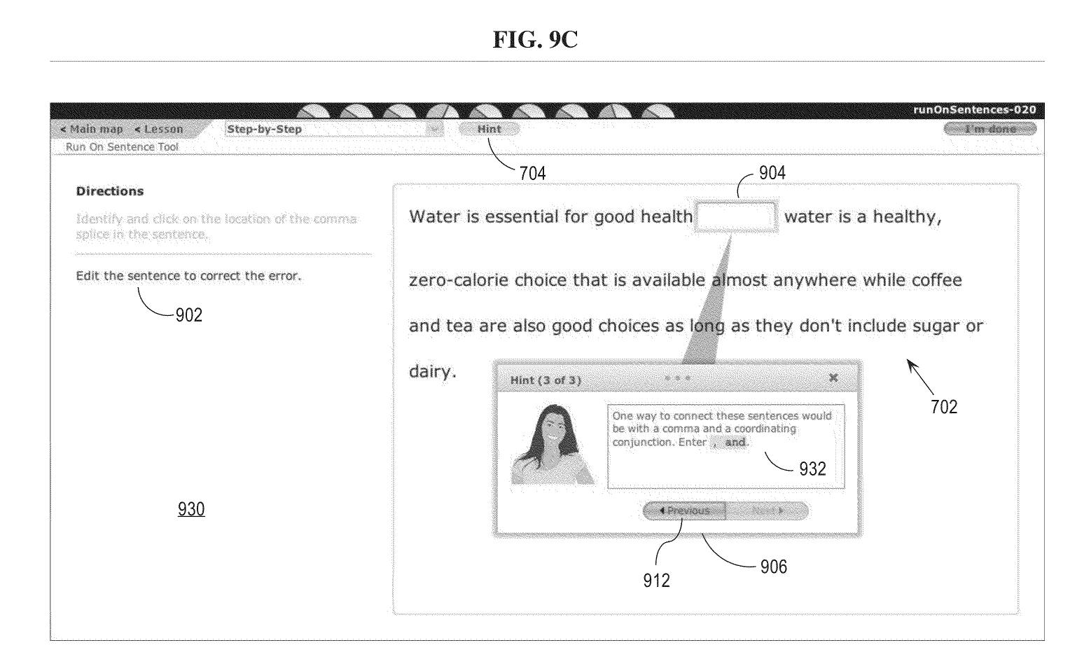

As another example of an ordered list of portions of hint information, FIGS. 9A-9C depict a second step of the grammar problem depicted in FIGS. 8A-8B. Specifically, FIGS. 9A-9C instruct the user (at directions 902) to edit the sentence to correct the error. In an embodiment, this step of the problem is displayed after the user selects the correct location of the grammar error, as instructed in FIGS. 8A-8B.

GUI 900 of FIG. 9A includes a text box control 904 at the location of the grammar error in sentence 702. Grammar client 112 detects a request for hint information from the user, e.g., by detecting activation of hint button 704. Grammar client 112 sends the request to hint service 126, which determines from historical information (or lack thereof) that this is the first time that the user has requested hint information for this step in the grammar problem with sentence 702. Therefore, hint service 126 instructs grammar client 112 to display a first portion of an ordered list of portions of hint information for the current grammar problem step. In response to these instructions, grammar client 112 displays hint control 906 with hint text 908 from the first portion of hint information in the ordered list. Hint text 908 includes additional information about the directions 902 for the current grammar problem step.

Grammar client 112 detects a second request for hint information, e.g., by a second activation of hint button 704, by activation of next button 910, etc. Grammar client 112 sends the second request for hint information to hint service 126, which determines that it is the second request for hint information and instructs grammar client 112 to display the second portion of hint information in the ordered list of portions of hint information for the current grammar problem step.

As illustrated by GUI 920 of FIG. 9B, grammar client 112 displays hint text 922 in hint control 906, which is the hint text associated with the second portion of hint information in the ordered list. In the embodiment depicted in GUI 920, the second portion of hint information includes details about the grammar error (“A comma splice often means that the author wanted the two sentences to be connected.”). The second portion of hint information also includes ideas that the user should think about in the user's attempt to correct the error (“Enter a word and/or punctuation to connect the sentences.”). As such, the second portion of hint information includes more details and/or guidance than the first portion of hint information with respect to completing the current grammar problem step. Such details can help the user identify misconceptions that the user holds for the grammar skills related to the current grammar problem step.

Grammar client 112 detects a third request for hint information, e.g., by activation of hint button 704, by activation of next button 910, etc. Grammar client 112 sends the third request for hint information to hint service 126, which determines that it is the third request for hint information and instructs grammar client 112 to display the third portion of hint information in the ordered list of portions of hint information for the current grammar problem step.

As illustrated by GUI 930 of FIG. 9C, grammar client 112 displays hint text 932 in hint control 906, which is the hint text associated with the third portion of hint information in the ordered list. In the embodiment depicted in GUI 930, the third portion of hint information includes at least one way to answer the current step of the grammar problem (“One way to connect these sentences would be with a comma and a coordinating conjunction. Enter, and.) As such, the third portion of hint information describes the nature of at least one accurate correction of the sentence and an example of an accurate correction. Thus, the third portion of hint information informs the user of the answer to the current step. Such an example answer can further help the user identify misconceptions that the user holds for the grammar skills related to the current grammar problem step. Thus, the user may be more ready to answer a similar problem in the future. In an embodiment, important portions of the hint text is highlighted, such as “, and” in hint text 932.

Activation of previous button 912 is not considered an additional request for hint information by the user within embodiments of the invention. While activation of previous button 912 causes the portion of hint information located immediately previous to the currently displayed portion of hint information to be displayed, it is a request to show hint information that was already displayed and not a request for new hint information.

According to an embodiment, when the user requests help information for the first time, grammar client 112 updates the mastery estimate for grammar skills associated with the current grammar problem step as if the user provided an incorrect answer. According to another embodiment in which the first portion of information includes only more specific instructions for the current step, when the user requests help information for the second time (and not the first time), grammar client 112 updates the mastery estimate for grammar skills associated with the current grammar problem step as if the user provided an incorrect answer.

### Hint Pointers

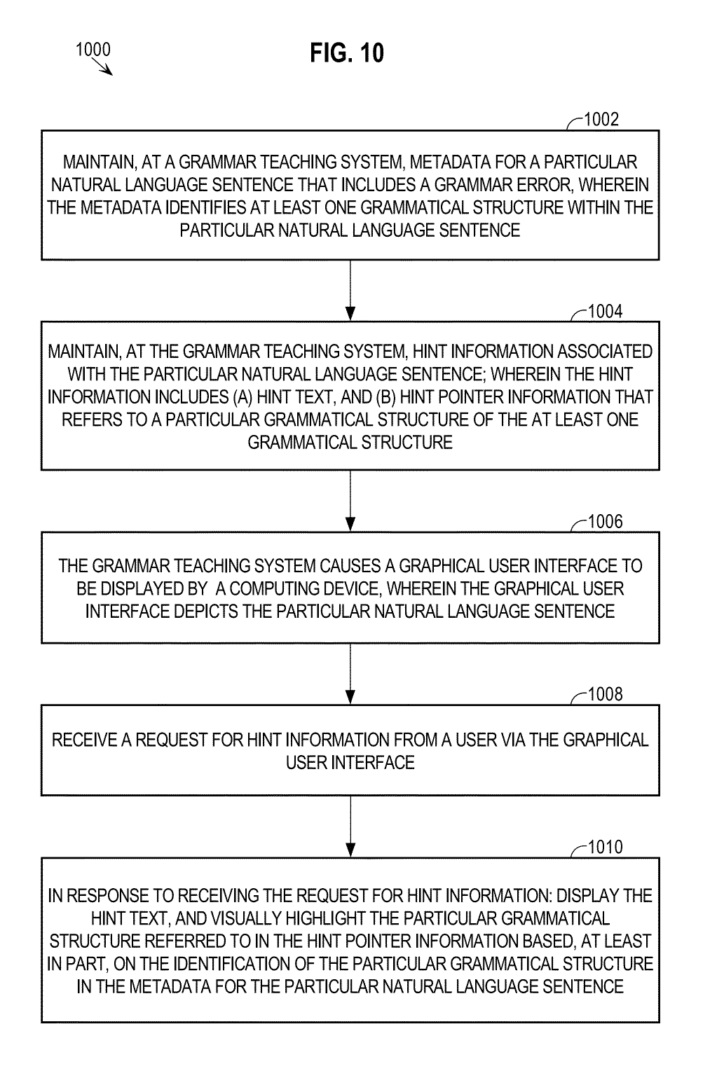

At times, the hint text for a particular portion of hint information associated with a particular grammar problem step refers to structures and/or locations within a displayed natural language sentence. According to embodiments, such a portion of hint information includes hint pointers, which allows grammar client 112 to highlight appropriate portions of the displayed sentence. FIG. 10 depicts a flowchart 1000 for using hint pointers to highlight portions of a displayed sentence in a grammar problem.

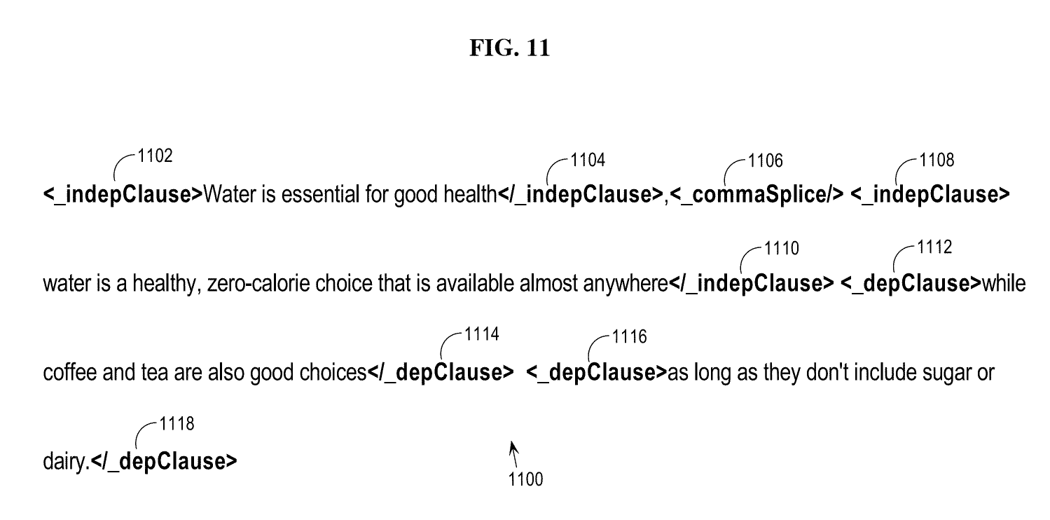

At step 1002, maintaining, at a grammar teaching system, metadata for a particular natural language sentence that includes a grammar error, wherein the metadata identifies at least one grammatical structure within the particular natural language sentence. For example, database 140 maintains, in problem data for a grammar problem, metadata that identifies the types and locations of grammatical structures within one or more of the natural language sentences for the problem. For example, FIG. 11 depicts natural language sentence 702 marked up with example metadata, referred to herein as marked-up sentence 1100. The form and format of the metadata depicted in FIG. 11 is non-limiting.

Metadata tags 1102 and 1108 (<_indepClause>) and metadata tags 1104 and 1110 (</_indepClause>) mark the beginnings and ends, respectively, of independent clauses within sentence 1100. Metadata tags 1112 and 1116 (<_depClause>) and metadata tags 1114 and 1118 (</_depClause>) mark the beginnings and ends, respectively, of dependent clauses within sentence 1100. Metadata tag 1106 (<_commaSplice/>) marks the location of the comma splice grammar error within the sentence. Other metadata tags may be used to mark grammatical structures within a natural language sentence. For example, in another embodiment, the metadata tags <_commaSplice> and </_commaSplice> come before and after, respectively, the comma in the sentence that creates the comma splice error (i.e., “ . . . good health</_indepClause><_commaSplice>,</_commaSplice><_indepClause>water is a healthy . . . . ”). According to an embodiment, a grammar error within a sentence is considered to be a grammatical structure.

At step 1004, the grammar teaching system maintains hint information associated with the particular natural language sentence, wherein the hint information includes (a) hint text, and (b) hint pointer information that refers to a particular grammatical structure of the at least one grammatical structure. In an embodiment, the included hint text is a reference to hint text stored in database 140. In another embodiment, the included hint text is a reference to a hint text template stored in database 140.

To illustrate step 1004, hint service 126 maintains in database 140, with the problem data for a particular grammar problem, hint information for a natural language sentence in the grammar problem. The hint information may be further associated with a step in the particular grammar problem. According to an embodiment, the hint information is part of an ordered list of portions of hint information.

The hint information associated with the particular natural language sentence includes hint text. For example, hint information associated with the natural language sentence 1100 includes the following hint text: “In this sentence, there are two independent clauses that have only a comma between them. Click on the location of the comma splice.”

The hint information associated with the particular natural language sentence also includes hint pointer information. The hint pointer information identifies at least one grammatical structure within at least one of the problem's natural language sentences. According to an embodiment, a hint pointer can refer to any portion of a natural language sentence that is identified by metadata associated with the natural language sentence. Continuing with the previous example, the hint information includes hint pointer information that refers to independent clauses and dependent clauses. According to an embodiment, the hint pointer information refers to the grammatical structures using the metadata tag name that identifies the structures in the marked-up version of the natural language sentence, e.g., “indepClause” in sentence 1100.

According to an embodiment, hint pointer information refers to a set of two or more locations, within a natural language sentence, that are potential locations of the grammar error in the sentence. In this embodiment, grammar client 112 highlights the set of two or more locations using a potential-answer-style highlight, as described in further detail below. In this embodiment, potential locations of the grammar error of a sentence are identified in the sentence using metadata stored for the sentence in the associated grammar problem data in database 140.

At step 1006, the grammar teaching system causes a graphical user interface to be displayed by a computing device, wherein the graphical user interface depicts the particular natural language sentence. For example, grammar service 122 causes grammar client 112 to display GUI 700 of FIG. 7. GUI 700 depicts natural language sentence 702, which includes the comma splice grammar error, as indicated above.

At step 1008, a request for hint information is received from a user via the graphical user interface. For example, a user activates hint button 704 in GUI 700. Grammar client 112 detects activation of hint button 704 and interprets the activation as a request for hint information from the user.

At step 1010, in response to receiving the request for hint information: the hint text is displayed, and the particular grammatical structure referred to in the hint pointer information is visually highlighted based, at least in part, on the identification of the particular grammatical structure in the metadata for the particular natural language sentence. For example, grammar client 112 communicates the request for hint information to hint service 126. In response to receiving the request for hint information, hint service 126 causes grammar client 112 to display hint control 1202 with hint text 1204 of GUI 1200 in FIG. 12. Hint text 1204 is from hint information associated with the displayed natural language sentence 702.

Also in response to receiving the request for hint information, hint service 126 causes grammar client 112 to visually highlight the grammatical structures in sentence 702 that are referred to in the hint pointer information in the hint information associated with sentence 702. For example, hint service 126 determines that the hint pointer information associated with hint text 1204 refers to the independent clauses of sentence 702. Hint service 126 identifies the positions of the words that are encompassed by a particular pair of independent clause metadata tags. To illustrate, hint service 126 determines that the first pair of independent clause metadata tags in the metadata for sentence 702 (depicted in sentence 1100 of FIG. 11 as metadata tags 1102 and 1104) encompass word numbers 0-5 of sentence 702. Hint service 126 instructs grammar client 112 to highlight words 0-5 of sentence 702 with an “independent clause” style highlight. In response to such instruction, grammar client 112 causes GUI 1200 to display the specified style of highlight for words 0-5 of the depicted sentence. Example GUI 1200 depicts words 0-5 of sentence 702 highlighted with an “independent clause” style highlight 1206.

In a similar manner, hint service 126 highlights words 6-17 with an “independent clause” style highlight 1208, words 18-25 with a “dependent clause” style highlight 1210, and words 26-34 with a “dependent clause” style highlight 1212.

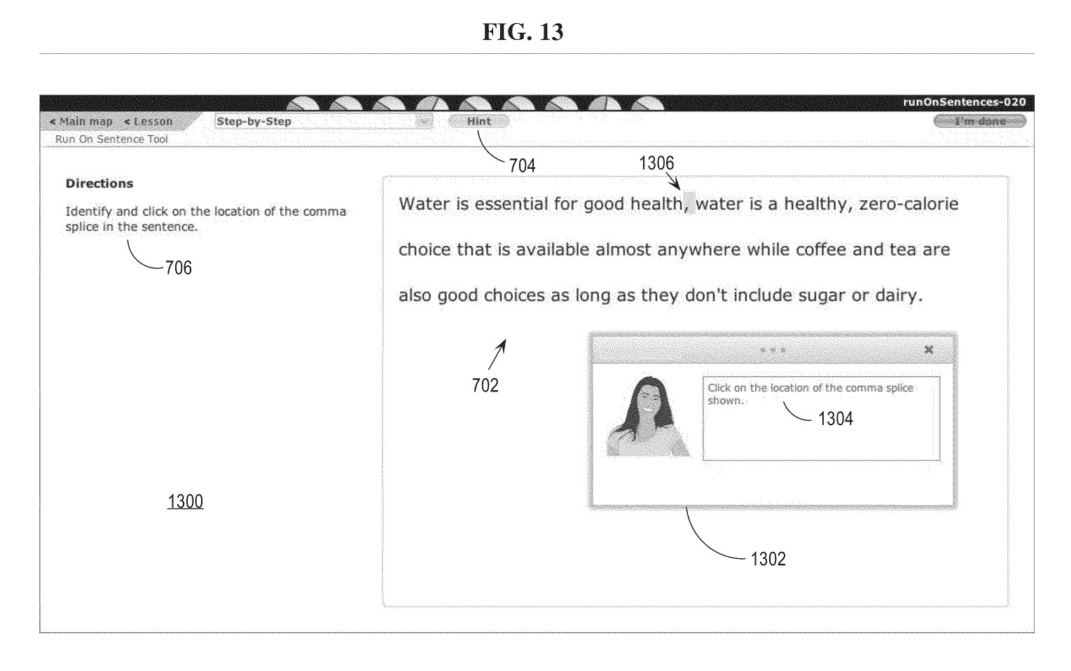

FIG. 13 depicts a GUI 1300 that displays hint text 1304 in hint control 1302 for second hint information for sentence 702. According to an embodiment, the second hint information follows the hint information displayed in GUI 1200 in an ordered list of portions of hint information associated with sentence 702.

When the user requests the additional hint information, hint service 126 determines that the second portion of hint information for sentence 702 includes hint pointer information that refers to the comma splice grammar error within sentence 702. Hint service 126 determines that the comma splice grammar error is at word-based position 5.5, (or between words 5 and 6) in sentence 702, based on metadata tag 1106 (of FIG. 11). Hint service 126 instructs grammar client 112 to highlight word-based position 5.5 in the depicted natural language sentence with a “comma splice grammar error” style highlight.

### Highlight Styles

According to embodiments, hint service 126 highlights portions of a displayed sentence with highlight styles based, at least in part, on the type of grammatical structure that is being highlighted. A particular style of highlighting is visually distinct from other styles of highlighting such that a user may quickly understand the types of grammatical structures of a sentence when two or more different styles of highlighting are used in a single depicted sentence, as with sentence 702 in GUI 1200.

According to embodiments, each style of highlight is displayed in a distinct color. For example, independent clause style highlights are blue, dependent clause style highlights are green, introductory element style highlights are orange, etc. Furthermore, the visual depiction of the highlight may vary according to embodiments. In an embodiment, a highlight comprises a line under the highlighted grammatical structure (as shown in GUI 1200). In an embodiment, a highlight comprises background color on the portion of the GUI that displays the highlighted grammatical structure (as shown in GUI 1300). In an embodiment, a highlight includes label text with a name of the highlighted grammatical structure or other identifying text (as shown in GUI 1200). According to further embodiments, other icons or other visual highlight methods are used to highlight a particular grammatical structure in a depicted sentence.

In an embodiment, a highlight for a grammar error is distinct from a highlight for other types of grammatical structures. For example, background colors are reserved for actual and potential locations of grammar errors. In an embodiment, one or more types of grammar errors have highlighting styles that are distinct from the other styles of highlights of other types of grammar errors. For example, a “comma splice grammar error” style highlight includes a label indicating the name of the grammar error, i.e., “Comma Splice”. According to another embodiment, hint service 126 highlights all kinds of grammar errors in a generic “grammar error” style highlight (such as a yellow background color, as with highlight 1306 of GUI 1300). According to yet another embodiment, hint service 126 determines that a comma splice grammar error is of the type “run-on sentence error”, which has an associated style of highlight, and applies the “run-on sentence error” style highlight to the location of a comma splice grammar error.

According to an embodiment, hint service 126 highlights portions of a sentence that are potential locations of a grammar error in a distinctive style, in other words, in a style different than any other highlight. Such a potential-answer-style highlight may comprise a background color that distinctly identifies this style of highlight (e.g., blue).

FIGS. 14A-14B depict highlighting of grammatical structures in natural language sentences in the context of a grammar problem with multiple displayed natural language sentences. For example, FIG. 14A depicts GUI 1400 with natural language sentences 1408, 1410, and 1412. Sentence 1410 is the subject of the current step of the grammar problem, and therefore, it is not grayed out. Likewise, sentences 1408 and 1412 are grayed out because these sentences are not the subject of the current grammar problem step.

Grammar client 112 displays, in hint control 1402, hint text 1404 from hint information at a second position in an ordered hint list associated with the current grammar problem step. This portion of hint information also includes hint pointer information that refers to the independent clauses in sentence 1410. In the manner described above, hint service 126 highlights the two independent clauses in sentence 1410 with highlights 1414 and 1416.

FIG. 14B depicts GUI 1420 with natural language sentences 1428, 1430, and 1432. Sentence 1430 is the subject of the current step of the grammar problem, and therefore, it is not grayed out. Likewise, sentences 1428 and 1432 are grayed out. Grammar client 112 displays, in hint control 1422, hint text 1424 from hint information in the second position in the ordered list of hint information associated with the current grammar problem step. This portion of hint information also includes hint pointer information that refers to the independent clauses and an introductory element in sentence 1430. In the manner described above, hint service 126 highlights the two independent clauses in sentence 1430 with highlights 1434 and 1438, and highlights the introductory element in sentence 1430 with highlight 1436.

### Selecting a Problem to Display to a User

Grammar service 122 selects problems, from database 140, to display to the user based, at least in part, on the estimates of the user's mastery of grammar skills Grammar service 122 presents a next problem to a user that includes at least one grammar skill in a list of grammar skills that the user still needs to master. This focus on grammar skills that have not yet reached the threshold mastery level ensures that the user will not underpractice unmastered grammar skills.

Once a user has reached a particular threshold mastery estimate for a particular grammar skill, grammar service 122 removes the particular grammar skill from the list of grammar skills that the user still needs to master. According to an embodiment, grammar service 122 considers a particular grammar skill to be mastered when the user attains at least the threshold probability of mastery for the grammar skill. For example, once a user attains over a threshold of 95% probability of mastery in a particular grammar skill, grammar service 122 removes that particular grammar skill from the list of grammar skills that the user needs to practice.

Furthermore, grammar service 122 identifies which grammar problem to display to a user based, at least in part, on user information stored at database 140. According to an embodiment, grammar service 122 is configured to maintain historical data for a user, e.g., in a user profile for the user stored at database 140. Such historical data includes one or more of: previous problems that have been presented to the user, types of previous problems that have been presented to the user, granular grammar skills and sub-skills associated with grammar problems that have been previously presented to the user, correct and incorrect answers given by the user, timing of viewing and answering presented questions, etc.

According to an embodiment, grammar service 122 identifies the next problem to present to a user based, at least in part, on the sub-skills associated with grammar problems that the user has already answered. To illustrate, if a granular grammar skill has multiple sub-skills associated therewith, then those grammar problems that are associated with the various sub-skills of the granular grammar skill represent different forms of sentences that can be used to demonstrate the granular grammar skill. In this embodiment, grammar service 122 ensures that a user is presented a variety of the forms of sentences that can be used to demonstrate the granular grammar skill using the granular grammar skill's sub-skills. For example, if a user is to be presented a problem associated with the particular granular grammar skill, and grammar service 122 has historical information indicating that the user has already answered a problem associated with a first sub-skill of the particular granular grammar skill, then grammar service 122 prefers presenting a problem associated with a second sub-skill of the particular granular grammar skill, where a grammar problem associated with the second sub-skill has not yet been presented to the user.

### Intelligent Tutoring System

According to an embodiment, grammar service 122 and/or grammar client 112 is implemented as part of an intelligent tutoring system, such as the cognitive tutor described in Kenneth R. Koedinger, John R. Anderson, William H. Hadley, & Mary A. Mark Intelligent tutoring goes to school in the big city §2.2 (7th World Conference on Artificial Intelligence in Education 1995), which paper is incorporated herein by reference.

### Learning the Mechanics of the Graphical User Interfaces

Step-by-step dropdown 1440 of FIG. 14B allows a user to learn how to interact with the graphical user interfaces produced by grammar service 122. According to an embodiment, when a user activates step-by-step dropdown 1440, the dropdown expands to reveal tutorial options (e.g., single sentence problem, multiple sentence problem, etc.). When a user selects a particular tutorial from the expanded dropdown, grammar service 122 displays a tutorial grammar problem that steps the user through answering the various steps of the tutorial grammar problem. Such a tutorial does not affect the user's mastery estimates for grammatical skills, but teaches the user the mechanics of the GUI.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

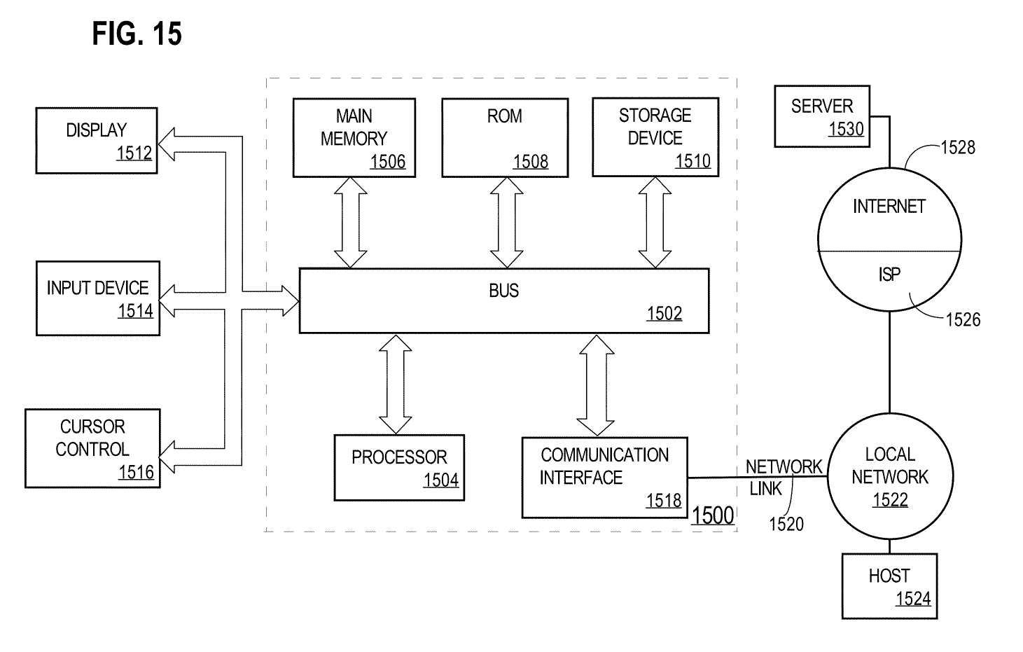

For example, FIG. 15 is a block diagram that illustrates a computer system 1500 upon which an embodiment of the invention may be implemented. Computer system 1500 includes a bus 1502 or other communication mechanism for communicating information, and a hardware processor 1504 coupled with bus 1502 for processing information. Hardware processor 1504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk, optical disk, or solid-state drive is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1510. Volatile media includes dynamic memory, such as main memory 1506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid-state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
maintaining, at a grammar teaching system, a mastery estimate of how well a user has mastered a particular grammar skill;
the grammar teaching system causing a computing device to display a visual indication of the mastery estimate for the particular grammar skill;
the grammar teaching system causing a graphical user interface that depicts a particular natural language sentence to be displayed by the computing device;
wherein the particular natural language sentence includes a grammar error, correction of which demonstrates the particular grammar skill;
receiving input information comprising a response, from the user, that indicates one or more of:
identification of the grammar error, or
correction of the grammar error;
the grammar teaching system automatically categorizing the response as either correct or incorrect;
based, at least in part, on the categorization of the response, the grammar teaching system updating the mastery estimate for the particular grammar skill; and
the grammar teaching system causing the computing device to update the visual indication of the mastery estimate for the particular grammar skill to reflect the updated estimation.

2. The method of claim 1, further comprising initializing the mastery estimate for the particular grammar skill based, at least in part, on one or more of: a non-user specific estimate, or analysis of a user's responses to a diagnostic quiz.

3. The method of claim 1, further comprising initializing the mastery estimate for the particular grammar skill based, at least in part, on grammatical analysis of a user's writing sample.

4. The method of claim 1, further comprising maintaining a plurality of mastery estimates for the user, wherein each mastery estimate of the plurality of mastery estimates corresponds to a corresponding grammar skill and indicates an estimate of how well the user has mastered the corresponding grammar skill.

5. The method of claim 1, further comprising, prior to the grammar teaching system causing the graphical user interface that depicts the particular natural language sentence to be displayed by the computing device:
maintaining, at the grammar teaching system, historical information indicating that the grammar teaching system previously displayed, to the user, a certain natural language sentence associated with a first sub-skill of a plurality of sub-skills of the particular grammar skill;
wherein the particular natural language sentence is associated with a second sub-skill of the plurality of sub-skills of the particular grammar skill;
determining that the grammar teaching system should display, to the user, a natural language sentence associated with the particular grammar skill;
based, at least in part, on the historical information, determining that the grammar teaching system should display a natural language sentence associated with a sub-skill, of the particular grammar skill, other than the first sub-skill; and
identifying the particular natural language sentence, from a plurality of natural language sentences, to display to the user based, at least in part, on the association between the particular natural language sentence with the second sub-skill;
wherein the grammar teaching system causes the graphical user interface that depicts the particular natural language sentence to be displayed by the computing device is in response to identifying the particular natural language sentence.

6. The method of claim 1, wherein:
the response from the user indicates at least correction of the grammar error; and
the method further comprises:
prior to receiving the input information comprising the response:
displaying, in a graphical user interface, two or more answer mechanisms,
receiving, via the graphical user interface, selection information indicating selection of a particular answer mechanism of the two or more answer mechanisms, and
in response to receiving the selection information, making the particular answer mechanism available, in the graphical user interface, for the user to input the input information comprising the correction of the grammar error; and
receiving input information comprising the response, from the user is via the particular answer mechanism.

7. A computer-executed method comprising:
maintaining, at a grammar teaching system, an ordered list of portions of hint information associated with a particular natural language sentence that includes a grammar error;
wherein the portions of hint information, from the ordered list of portions of hint information, each corresponds to hint text;
the grammar teaching system causing a computing device to display a graphical user interface that depicts the particular natural language sentence;
receiving a request for hint information from a user via the graphical user interface;
in response to receiving the request for hint information, selecting a position in the ordered list based on how many times the user has previously requested hint information for the particular natural language sentence; and
displaying the hint text for a particular portion of hint information that corresponds to the selected position.

8. The method of claim 7, wherein:
correction of the grammar error in the particular natural language sentence demonstrates a particular grammar skill; and
the hint text for at least one of the ordered list of portions of hint information describes at least one aspect of the particular grammar skill.

9. The method of claim 7, wherein the portions of hint information in the ordered list are ordered based on a kind of information in the corresponding hint text of each portion of hint information in the ordered list.

10. The method of claim 9, wherein:
a first portion of hint information at a first position in the ordered list includes details about instructions for answering a current step in a current problem for the particular natural language sentence;
a second portion of hint information at a second position in the ordered list includes details about grammatical structures within the particular natural language sentence; and
a third portion of hint information at a third position in the ordered list includes at least one of a set of one or more possible correct answers to complete the current step of the current problem.

11. The method of claim 7, further comprising:
prior to displaying the hint text:
identifying a hint template for the particular portion of hint information that corresponds to the selected position, and
constructing constructed hint text for the particular portion of hint information by replacing one or more placeholders in the identified hint template with one or more values from grammar problem data for the particular natural language sentence;
wherein displaying the hint text for the particular portion of hint information that corresponds to the selected position comprises displaying the constructed hint text.

12. The method of claim 7, further comprising:
maintaining, at the grammar teaching system, metadata for the particular natural language sentence;
wherein the metadata identifies at least one grammatical structure within the particular natural language sentence;
wherein the particular portion of hint information includes hint pointer information that refers to a particular grammatical structure of the at least one grammatical structure;
in response to receiving the request for hint information, visually highlighting the particular grammatical structure referred to in the hint pointer information based, at least in part, on the identification of the particular grammatical structure in the metadata for the particular natural language sentence.

13. A computer-executed method comprising:
maintaining, at a grammar teaching system, metadata for a particular natural language sentence that includes a grammar error;
wherein the metadata identifies at least one grammatical structure within the particular natural language sentence;
maintaining, at the grammar teaching system, hint information associated with the particular natural language sentence;
wherein the hint information includes (a) hint text, and (b) hint pointer information that refers to a particular grammatical structure of the at least one grammatical structure;
the grammar teaching system causing a graphical user interface to be displayed by a computing device, wherein the graphical user interface depicts the particular natural language sentence;
receiving a request for hint information from a user via the graphical user interface; and
in response to receiving the request for hint information:
displaying the hint text, and
visually highlighting the particular grammatical structure referred to in the hint pointer information based, at least in part, on the identification of the particular grammatical structure in the metadata for the particular natural language sentence.

14. The method of claim 13, wherein:
the metadata identifies a location of the grammar error within the particular natural language sentence;
the particular grammatical structure referred to by the hint pointer information is the grammar error; and
visually highlighting the particular grammatical structure referred to in the hint pointer information comprises visually highlighting the location of the grammar error in the graphical user interface.

15. The method of claim 13, wherein visually highlighting the particular grammatical structure comprises:
identifying a type of the particular grammatical structure;
selecting a style of highlight based, at least in part, on the type of the particular grammatical structure; and
visually highlighting the particular grammatical structure with the selected style of highlight.

16. The method of claim 15, wherein a first style of highlight for a first type of grammatical structure is visually distinct from a second style of highlight for a second type of grammatical structure based, at least in part, on one or more of:
color of the styles of highlight;
label text associated with the styles of highlight; or
visual depiction of the styles of highlight.

17. A non-transitory computer readable medium storing instructions which, when executed by one or more processors, cause performance of the steps of:
maintaining, at a grammar teaching system, an estimation of how well a user has mastered a particular grammar skill;
the grammar teaching system causing a computing device to display a visual indication of the mastery estimate for the particular grammar skill;
the grammar teaching system causing a graphical user interface that depicts a particular natural language sentence to be displayed by the computing device;
wherein the particular natural language sentence includes a grammar error, correction of which demonstrates the particular grammar skill;
receiving input information comprising a response, from the user, that indicates one or more of:
identification of the grammar error, or
correction of the grammar error;
the grammar teaching system automatically categorizing the response as either correct or incorrect;
based, at least in part, on the categorization of the response, the grammar teaching system updating the mastery estimate for the particular grammar skill; and
the grammar teaching system causing the computing device to update the visual indication of the mastery estimate for the particular grammar skill to reflect the updated estimation.

18. A non-transitory computer readable medium storing instructions which, when executed by one or more processors, cause performance of the steps of:
maintaining, at a grammar teaching system, an ordered list of portions of hint information associated with a particular natural language sentence that includes a grammar error;
wherein the portions of hint information, from the ordered list of portions of hint information, each corresponds to hint text;
the grammar teaching system causing a computing device to display a graphical user interface that depicts the particular natural language sentence;
receiving a request for hint information from a user via the graphical user interface;
in response to receiving the request for hint information, selecting a position in the ordered list based on how many times the user has previously requested hint information for the particular natural language sentence; and
displaying the hint text for a particular portion of hint information that corresponds to the selected position.

19. A non-transitory computer readable medium storing instructions which, when executed by one or more processors, cause performance of the steps of:
maintaining, at a grammar teaching system, metadata for a particular natural language sentence that includes a grammar error;
wherein the metadata identifies at least one grammatical structure within the particular natural language sentence;
maintaining, at the grammar teaching system, hint information associated with the particular natural language sentence;
wherein the hint information includes (a) hint text, and (b) hint pointer information that refers to a particular grammatical structure of the at least one grammatical structure;
the grammar teaching system causing a graphical user interface to be displayed by a computing device, wherein the graphical user interface depicts the particular natural language sentence;
receiving a request for hint information from a user via the graphical user interface; and
in response to receiving the request for hint information:
displaying the hint text, and
visually highlighting the particular grammatical structure referred to in the hint pointer information based, at least in part, on the identification of the particular grammatical structure in the metadata for the particular natural language sentence.
